(19) United States
(12) Patent Application Publication
(10) Pub. No.: US 2025/0084556 A1
(43) Pub. Date: Mar. 13, 2025

(54) SYSTEMS AND METHODS FOR AFFECTING SURFACES OF ELECTRICALLY CONDUCTIVE MATERIALS

(71) Applicant: MetCon Technologies, LLC, Monaca, PA (US)

(72) Inventors: James CLASQUIN, Monaca, PA (US); Kurt FALLER, Monaca, PA (US)

(21) Appl. No.: 18/554,452

(22) PCT Filed: May 19, 2023
(86) PCT No.: PCT/US2023/022874

§ 371 Date: Oct. 6, 2023

Related U.S. Application Data
(60) Provisional application No. 63/343,933, filed on May 19, 2022.

(51) Int. Cl. C25F 3/24; C25D 11/02; C25D 11/06; C25D 11/26; C25F 1/08; C25F 3/20; C25F 3/22; C25F 3/26; C25F 7/00

(52) U.S. Cl. CPC C25F 3/24; C25D 11/024; C25D 11/06; C25D 11/26; C25F 1/08; C25F 3/20; C25F 3/22; C25F 3/26; C25F 7/00

(57) ABSTRACT

Systems and methods for beneficially affecting the surface morphology of electrically conductive materials using electrochemistry are described. The systems and methods for beneficially affecting the surface morphology of electrically conductive materials use a bimodal process in which a first current type (alternating or direct) is applied across an electrolyte between an electrode and a workpiece followed by applying a second current type different from the first current type is used. The bimodal process may be repeated one or more times.

### CROSS REFERENCE TO RELATED APPLICATIONS

This application claims the benefit of priority to U.S. Provisional Patent Application No. 63/343,933, filed May 19, 2022, and entitled “SYSTEMS AND METHODS FOR AFFECTING SURFACES OF ELECTRICALLY CONDUCTIVE MATERIALS”, the entirety of which is hereby incorporated by reference.

### TECHNICAL FIELD

The technology described herein generally relates to systems and methods for beneficially affecting the surface morphology of electrically conductive materials using electrochemistry. More specifically, the technology described herein relates to systems and methods for beneficially affecting the surface morphology of electrically conductive materials using a bimodal process in which a first current type (alternating or direct) is applied across an electrolyte between an electrode and a workpiece followed by applying a second current type different from the first current type is used. The bimodal process may be repeated one or more times.

### BACKGROUND

Electrochemical methods of affecting the surface of materials are primarily based on Faraday's Laws of Electrolysis. In essence, the result of electrochemical operations is directly proportional to the charge introduced to the system. When the polarity of an electrode is constantly maintained, the change at said electrode can be anticipated via the charge introduced. In the example of electrodeposition, for a total number of electrons flowing into a system (typically measured in ampere-time units), a fixed number of cationic species will be deposited onto the electrode in question. Where these cations will deposit, how uniformly they are distributed, and the functional and cosmetic characteristics of the deposit are controlled by other factors.

In practice, there are rate limiting steps to these outcomes, influenced primarily by mass transfer mechanisms around the electrode. Again using the example of electrodeposition, when depositing metals onto an electrode, the replenishment of fresh ionic species to the workpiece is constrained at the remarkably thin interfacial layer by diffusion, convection, and migratory methods of the actual chemical solutions. Diffusion, the random movement of molecules from a high concentration region to a lower concentration, creates an impediment to the uniform distribution of chemical species within this layer, resulting in an interference barrier. Likewise, hydrodynamic forces within the electrochemical cell, either by mechanical stirring/mixing or by differential heat transfer, can improve mass transfer efficacy, but localized excessive turbulence or laminar flow can also create a barrier to overcome. And finally, the movement of charged particles flowing within a localized electric field causing concentration gradients of ionic species is a further component to the interference barrier.

Because of these constraints around the working electrode, undesired outcomes are realized unless operational boundaries are placed on operational parameters. Continuing with the example of electrodeposition, if the rate of the introduced charge is too high, non-uniform and even uncontrolled deposition of the ionic species will occur. Conversely, if the rate of introduced charge is too low, chemical deterioration of the deposit can be encountered by the chemical nature of the electrolyte itself. The typical result is chemical attack, often in the form of undesired detrimental pitting of the electrode.

Advances in the art of electrochemical operations since Faraday introduced his Laws of Electrolysis have been primarily focused on developing and expanding either the nature of the chemical species involved or enhancing the mechanical methods of overcoming the issues within the interference barrier. A large variety of chemical species have been discovered and introduced to beneficially effect electrochemical outcomes, such as surfactants and chelators. Also, mechanical methods of solution agitation or concentration of the delivery of the solution chemistry have progressed over time. Specifically, sparging devices have been designed and added for better solution agitation, as have the delivery methods of the electrolyte as seen in the field of Electrochemical Machining (ECM).

These more recent developments are generally designed to minimize the detrimental effect of slowly replenishing the barrier layer that is adjacent to the electrode in question. A subset of these methods is aimed at advancing “detrimental” (i.e., roughening) surface effects on the electrode. In some outcomes, deteriorating or roughening the surface morphology of electrodes can have practical value. This is evidenced by the destructive outcome of “etching” an electrode so that it's surface porosity or irregularities become integral to the adhesion of subsequent layers. This outcome is advantageous when the material in question rapidly forms an oxide when exposed to air that interferes with adhesion of subsequent layers. Aluminum lithography plates are processed to detrimentally effect (i.e., roughen) surface morphology to create a surface that readily accepts subsequent application of ink. This roughened surface morphology is typically considered detrimental because it leads to stress corrosion cracking, reduced fatigue life, or the requirement for subsequent application of additive secondary layers to overcome the irregularities. There are limited applications where roughening of the surface morphology delivers a benefit to an application.

In view of the above, further improvements in electrochemical processing to beneficially affect the surface of a workpiece are still desired.

### SUMMARY

This Summary is provided to introduce a selection of concepts in a simplified form that are further described below in the Detailed Description. This Summary, and the foregoing Background, is not intended to identify key aspects or essential aspects of the claimed subject matter. Moreover, this Summary is not intended for use as an aid in determining the scope of the claimed subject matter.

In some embodiments, a bimodal method of affecting the surface of an electrically conductive workpiece is disclosed. The method may include the steps of immersing a surface of an electrically conductive metal workpiece in an electrolyte solution; immersing at least a surface of an electrode in the electrolyte solution; initiating a first operational mode, the first operational mode including either applying a direct current across the electrolyte solution between the electrically conductive metal workpiece and the electrode or applying an alternating current across the electrolyte solution between the electrically conductive metal workpiece and the electrode; terminating the first operational mode; initiating a second operational mode, the second operational mode including either applying an alternating current across the electrolyte solution between the electrically conductive metal workpiece and the electrode or applying a direct current across the electrolyte solution between the electrically conductive metal workpiece and the electrode, the second operational mode employing a different current type than the first operational mode; and terminating the second operational mode. The first operational mode and the second operational mode may be performed sequentially one or more times. The material of the conductive metal workpiece may comprise (1) pure Ti, Zr, Nb, Hf, Ta, or V, or Ti-, Zr-, Nb-, Hf-, Ta-, or V-based alloys; (2) pure Ni, Ni-based alloys, Co-based alloys, or titanium aluminides; (3) austenitic stainless steel; (4) martensitic stainless steel; (5) ferritic stainless steel, carbon steel, or alloy steel; (6) pure aluminum or aluminum alloys; or (7) pure copper or copper alloys.

In some embodiments, a system for affecting the surface of an electrically conductive metal workpiece is disclosed. The system may include an electrolyte solution bath; an electrically conductive metal workpiece, at least one surface of which is immersed in the electrolyte solution bath; an electrode, at least one surface of which is immersed in the electrolyte solution bath; a DC power supply, wherein a first terminal of the DC power supply is connected to the electrically conductive metal workpiece and a second terminal of the DC power supply is connected to the electrode; and an AC power supply, wherein a first terminal of the AC power supply is connected to the electrically conductive metal workpiece and a second terminal of the AC power supply is connected to the electrode. The system is configured such that, in a first operational mode, either the DC power supply applies only direct current across the electrolyte solution between the electrically conductive metal workpiece and the electrode or the AC power supply applies only alternating current across the electrolyte solution between the electrically conductive metal workpiece and the electrode, and in a second operational mode, either the AC power supply applies only alternating current across the electrolyte solution between the electrically conductive metal workpiece and the electrode or the DC power supply applies only direct current across the electrolyte solution between the electrically conductive metal workpiece and the electrode. The system is further configured such that the first operational mode employs a different current type than the second operational mode. In operation, the system alternates between the first operational mode and the second operational mode. The material of the conductive metal workpiece may comprise (1) pure Ti, Zr, Nb, Hf, Ta, or V, or Ti-, Zr-, Nb-, Hf-, Ta-, or V-based alloys; (2) pure Ni, Ni-based alloys, Co-based alloys, or titanium aluminides; (3) austenitic stainless steel; (4) martensitic stainless steel; (5) ferritic stainless steel, carbon steel, or alloy steel; (6) pure aluminum or aluminum alloys; or (7) pure copper or copper alloys.

As set forth above, the methods and systems described herein are applicable to seven separate and distinct workpiece material categories. While not wishing to be bound by theory, the ability to affect these different types of materials through a bimodal application of power as described herein may be attributable to the nature of the behavior of elements of the periodic table included within the different material categories. When Mendelev originally organized the period table, it was an attempt to arrange the elements with the most similar properties arranged in vertical columns. Additionally, the groups are also arranged in relation to the number of protons in the element, and correspondingly the number of electrons. As electrons exist within a series of increasingly complex shells, and through the Bohr model of electron behavior, the vertical groups of elements are also arranged such that each column reflects the number of electrons in their valence shell. As a result, the ability to influence and interact with these valence electrons provides a means to understand two aspects of technology described herein. The material category distinctions disclosed herein are arranged in part by this valence electron grouping. Metals like titanium, vanadium, niobium, and others share similar valence electron configurations, and thus are grouped together for purposes of the technology described herein. And secondarily, it is believed that via the bimodal application of external power as described herein, impacts to the valence electrons can be affected through electrochemical, electromotive and electromagnetic properties.

These and other aspects of the technology described herein will be apparent after consideration of the Detailed Description and Figures herein. It is to be understood, however, that the scope of the claimed subject matter shall be determined by the claims as issued and not by whether given subject matter addresses any or all issues noted in the Background or includes any features or aspects recited in the Summary.

### BRIEF DESCRIPTION OF THE DRAWINGS

Non-limiting and non-exhaustive embodiments of the disclosed technology, including the preferred embodiment, are described with reference to the following figures, wherein like reference numerals refer to like parts throughout the various views unless otherwise specified.

FIG. 1 is a schematic illustration of a system for beneficially affecting the surface of an electrically conductive metal workpiece configured in accordance with various embodiments described herein.

FIG. 2 is a flow chart illustrating a method for beneficially affecting the surface of an electrically conductive metal workpiece configured in accordance with various embodiments described herein.

FIGS. 3A and 3B illustrate various exemplary operational schemes for the methods and systems configured in accordance with various embodiments described herein.

FIG. 4 is a table summarizing Grit Finish and Estimated RMS and Ra Values.

FIGS. 5A and 5B are tables summarizing data for experimental trials carried out on Workpiece Material Category 1-Reactive Metals using systems and methods configured in accordance with various embodiments described herein.

FIGS. 6A-6E are tables summarizing data for experimental trials carried out on Workpiece Material Category 2-High Temperature/High Strength Metals using systems and methods configured in accordance with various embodiments described herein.

FIGS. 7A-7F are tables summarizing data for experimental trials carried out on Workpiece Material Category 3-Austenitic Stainless Steel using systems and methods configured in accordance with various embodiments described herein.

FIG. 8 is a table summarizing data for experimental trials carried out on Workpiece Material Category 4-Martensitic Stainless Steel using systems and methods configured in accordance with various embodiments described herein.

FIG. 9A-9D are tables summarizing data for experimental trials carried out on Workpiece Material Category 5-Ferritic Stainless Steel, Carbon Steel, Alloy Steel using systems and methods configured in accordance with various embodiments described herein.

FIG. 10 is a table summarizing data for experimental trials carried out on Workpiece Material Category 6-Aluminum and Aluminum Alloys using systems and methods configured in accordance with various embodiments described herein.

FIG. 11 is a table summarizing data for experimental trials carried out on Workpiece Material Category 7-Copper and Copper Alloys using systems and methods configured in accordance with various embodiments described herein.

### DETAILED DESCRIPTION

Embodiments are described more fully below with reference to the accompanying Figures, which form a part hereof and show, by way of illustration, specific exemplary embodiments. These embodiments are disclosed in sufficient detail to enable those skilled in the art to practice the invention. However, embodiments may be implemented in many different forms and should not be construed as being limited to the embodiments set forth herein. The following detailed description is, therefore, not to be taken in a limiting sense.

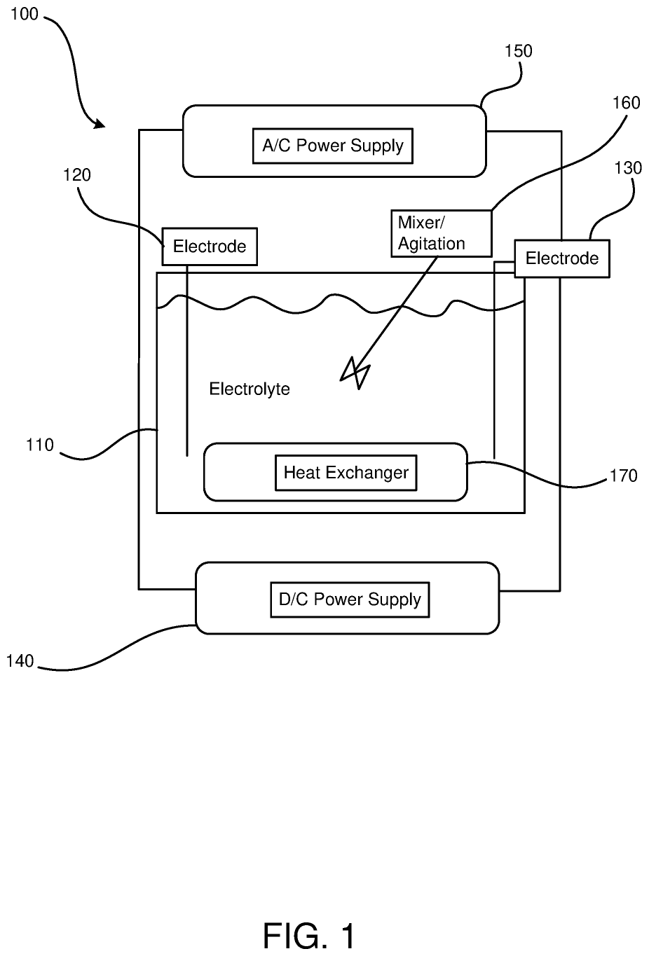

With reference to FIG. 1, a system 100 for beneficially affecting a surface of an electrically conductive metal workpiece is shown. The system 100 generally includes an electrolyte solution bath 110, an electrically conductive metal workpiece 120, an electrode 130, a DC power supply 140 and an AC power supply 150. The system 100 may also optionally include a mixing device 160 (shown as a mechanical mixer in FIG. 1) and/or a heating element 170 (shown as a heat exchanger in FIG. 1).

The configuration of the system 100 is such that at least one surface of the electrically conductive metal workpiece 120 and at least one surface of the electrode 130 are immersed in the electrolyte solution bath 110. In some embodiments, most or all of the electrically conductive metal workpiece 120 and/or most or all of the electrode 130 may be immersed in the bath 110. The minimum distance between the electrically conductive metal workpiece 120 and the electrode 130 is 0.003 inches. This minimum separation distance is provided due to practical limitations. As the distance between the workpiece 120 and the electrode 130 approach zero, there is a corresponding increase in electrical energy concentrated in an increasingly small volume. Theoretically this distance can be infinitesimally small, but pragmatically, distances less than 0.003 inches become difficult to manage from a mass and heat transfer standpoint. Any distance greater than 0.003 inches can be used provided that current can pass between the electrically conductive metal workpiece 120 and the electrode 130.

The configuration of the system 100 further includes electrically connecting each of the electrically conductive metal workpiece 120 and the electrode 130 to the DC power supply 140 and the AC power supply 150. The specific terminal of the DC power supply 140 to which each of the electrically conductive metal workpiece 120 and the electrode 130 is connected is generally not limited, and may depend on the specific beneficial process being carried out (electrodeposition, electrochemical removal, etc.). In some embodiments, the positive terminal of the DC power supply 140 is connected to the electrically conductive metal workpiece 120 and the negative terminal of the DC power supply 140 is connected to the electrode 130. In some embodiments, the negative terminal of the DC power supply 140 is connected to the electrically conductive metal workpiece 120 and the positive terminal of the DC power supply 140 is connected to the electrode 130. The DC power supply 140 may also be configured to switch poles, though the intent of the DC power supply 140 is not to provide an equivalent or approximation to alternating current. The specific terminal of the AC power supply 150 to which each of the electrically conductive metal workpiece 120 and the electrode 130 is connected is generally not limited.

The system 100 may optionally include a means for mixing/agitating the electrolyte solution bath. As shown in FIG. 1, a mixing/agitating device 160 is included as part of system 100 and may be configured to mix/agitate the electrolyte solution bath before, during and/or after the application of current from either or both of the DC power supply 140 and the AC power supply 150. In some embodiments, the mixing/agitating device 160 is a mechanical mixing/agitating device, such as a propeller or stir bar, though any suitable mechanical mixing/agitating device can be used. In some embodiments, the mixing/agitating device 160 is a thermal mixing/agitating device.

The system 100 may optionally include a means for heating the electrolyte solution bath. As shown in FIG. 1, a heating device 170 is included as part of system 100 and may be configured to alter the temperature of the electrolyte solution bath before, during and/or after the application of current from either or both of the DC power supply 140 and the AC power supply 150. The heating device 170 may be used to heat and/or cool the electrolyte solution bath. Any suitable heating mechanism may be used for the heating device 170, including, but not limited to, a heat exchanger as shown in FIG. 1. While FIG. 1 illustrates the heating device 170 being located within the electrolyte bath solution, the heating element 170 may be located anywhere about the system 100 provided that the location of heating element 170 allows for heating (or cooling) the electrolyte bath solution.

Additional information regarding the material composition of, e.g., the workpiece 120, the electrolyte solution 110, etc., and the operation of the overall system 100 and the individual components of the system 100 is provided below.

In application, the system 100 shown in FIG. 1 may be used to beneficially affect a surface of an electrically conductive metal workpiece at least by operating in two modes. In a first mode, the system 100 operates to apply a first type of current across the electrolyte bath between the electrically conductive metal workpiece and the electrode (e.g., direct current or alternating current), while in a second mode, the system 100 operates to apply a second type of current different from the first type of current across the electrolyte bath between the electrically conductive metal workpiece and the electrode. For example, if the first operational mode employs direct current, then the second operational mode employs alternating current, while if the first operational mode employs alternating current, the second operational mode employs direct current. The system alternates between the first operational mode and the second operational mode one or more times, with no practical limit to the number of times the first and second operational modes are sequentially performed. The operational modes generally do not overlap, meaning there is generally no coincident application of alternating and direct current. In other words, the first operational mode is terminated (the first current type is terminated) before initiating of the second operational mode (the second current type is initiated). While there is generally no coincident application of alternating and direct current, it should be appreciated that the time between termination of the first operational mode and initiation of the second operational mode can be extremely short such that the transition from a first current type to a second current type is essentially instantaneous. Alternatively, longer periods of time in which neither type of current is applied may exist between termination of the first operational mode and initiation of the second operational mode.

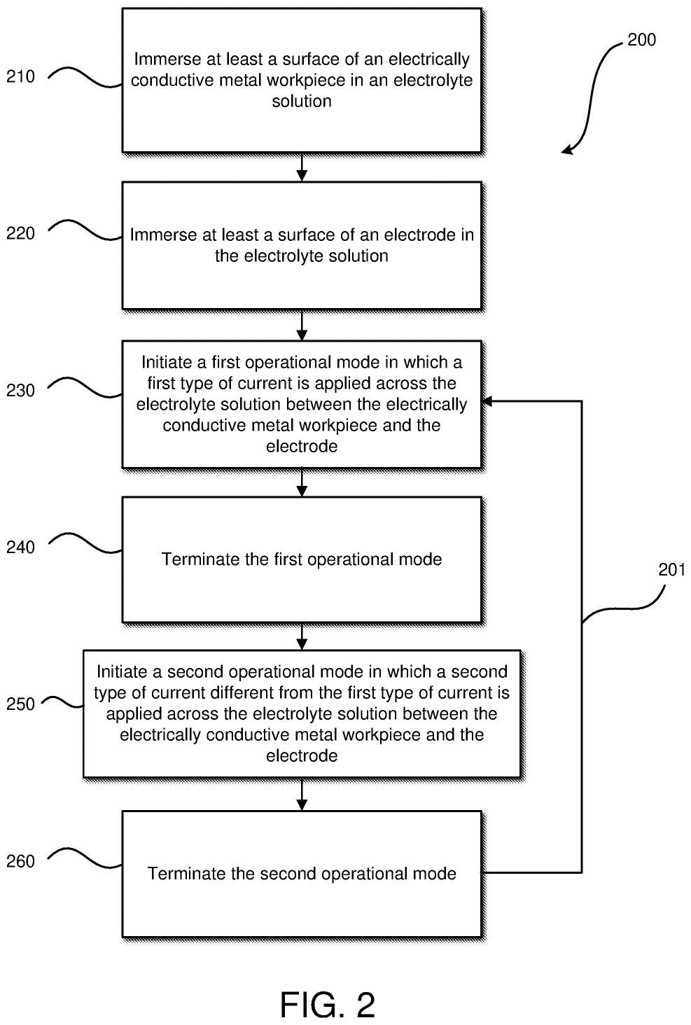

With respect to FIG. 2, a method 200 of beneficially affecting a surface of an electrically conductive metal workpiece, and which may use the system 100 shown in FIG. 1 for carrying out the method 200, is shown. Method 200 generally includes a step 210 of immersing at least a surface of an electrically conductive metal workpiece in an electrolyte solution; a step 220 of immersing at least a surface of an electrode in the electrolyte solution; a step 230 of initiating a first operational mode in which a first type of current (i.e., direct or alternating current) is applied across the electrolyte solution between the electrically conductive metal workpiece and the electrode; a step 240 of terminating the first operational mode; a step 250 of initiating a second operational mode in which a second type of current different from the first type of current is applied across the electrolyte solution between the electrically conductive metal workpiece and the electrode; and a step 260 of terminating the second operation mode. As shown in FIG. 2 via arrow 201, steps 230, 240, 250, and 260 may be performed once or multiple times.

With respect to steps 210 and 220 of immersing at least a surface of an electrically conductive metal workpiece in an electrolyte solution and immersing at least a surface of an electrode in the electrolyte solution, the immersion of the workpiece and the electrode can be to any level. As previously described, the workpiece can be mostly or totally immersed, or only a surface of the workpiece and the electrode can be immersed.

The size and shape of the workpiece and the electrode used in steps 210 and 220, respectively, are generally not limited.

The electrode immersed in the electrolyte solution can be any material known to be suitable for use as an electrode and which is materially compatible with the material of the workpiece. In some embodiments, the electrode material provides the necessary complementary chemical species needed for the desired electrochemical reaction (i.e., the desired manner of advantageously affecting the surface of the workpiece). In some embodiments, the electrode material is a chemically inert material. In embodiments where the aim of the process is to deposit material on the workpiece, then the electrode may be of a material that provides for chemical species to be removed from the electrode. In embodiments where the aim of the process is to remove material from the workpiece, then the electrode may be of a material that can receive material thereon.

The workpiece immersed in the electrolyte solution has a material composition that generally falls into one of seven distinct and separate categories, with each category of material potentially requiring different operational parameters and/or providing different outcomes. The seven material categories are workpieces comprising: (1) pure Ti, Zr, Nb, Hf, Ta, or V, or Ti-, Zr-, Nb-, Hf-, Ta-, or V-based alloys; (2) pure Ni, Ni-based alloys, Co-based alloys, or titanium aluminides; (3) austenitic stainless steel; (4) martensitic stainless steel; (5) ferritic stainless steel, carbon steel, or alloy steel; (6) pure aluminum or aluminum alloys; or (7) pure copper or copper alloys.

The term alloy as used herein generally means a metallic substance composed of two or more elements as a compound or a solution. When the term alloy is used together with a metal (e.g., Co-based alloy, Ni-based alloy, etc.) the specifically referenced metal is the predominant metal present in the alloy. Predominant means the highest percent metallic element, and does not require greater than 50%. The components of alloys are ordinarily themselves metals, though carbon, a non-metal, may be an essential component of some alloys (e.g., carbon is an essential component in steel). The distinction between an alloying element and an impurity is sometimes subtle, as some elements, such as oxygen or silicon, may be considered an impurity or a valuable component, depending on application. Commercially recognized common names and/or, where available, a metal's associated Unified Numbering System (“UNS”) number pertain to specific metals or alloys in order to define each metal's specific chemical composition.

The term pure as used herein means greater than 99 wt %.

With respect to the first workpiece material category, the workpiece includes a reactive metal, the reactive metals including Ti, Zr, Nb, Hf, Ta, and V. As such, the workpiece may be pure Ti, Zr, Nb, Hf, Ta, or V, or may be an alloy of any of Ti, Zr, Nb, Hf, Ta, or V. Ti-based workpieces can be made from pure titanium or titanium alloys. Titanium alloys include common titanium alloys (e.g., Ti-CP, Ti-64, Ti-10-2-3, Ti-5553, Ti-3Al-2.5V, ATI-425, Ti-Beta-C) and titanium alloys including molybdenum and/or tin (e.g., Ti-6242, Ti-6246). Pure titanium and titanium alloys belong to the UNS R5 category and have designations such as UNS R50400 (Ti-CP2) and UNS R56400 (Ti-6Al-4V). Zr-based workpieces can be made from pure Zr or Zr alloys. Pure zirconium and zirconium alloys belong to the UNS R6 category and have designations such as UNS R60802 (Zicraloy-2) and UNS R60702 (Zr 702 alloy). Nb-based workpieces can be made from pure Nb or Nb alloys. Pure niobium and niobium alloys belong to the UNS R04 category and have designations such as UNS R04210 (Niobium type 2) and UNS R04261 (Niobium Type 4). Hf-based workpieces can be made from pure Hf or Hf alloys. Pure hafnium and hafnium alloys belong to the UNS R02 category and have the primary designation UNS R02001 (for pure hafnium or hafnium used for alloy addition in other metals). Ta-based workpieces can be made from pure Ta or Ta alloys. Pure tantalum and tantalum alloys belong to the UNS R05 category and have designations such as UNS R05255 (Ta-10 W)) and UNS R05240 (Ta-40Nb). V-based workpieces can be made from pure V or V alloys. Pure vanadium and vanadium alloys belong to the UNS category R08. Commercial grades of vanadium or vanadium alloys have not been assigned specific UNS numbers at this time.

With respect to the second workpiece material category, the workpiece includes high temperature/high strength metals, the high temperature/high strength metals including pure Ni, Ni-based alloys, Co-based alloys, or titanium aluminides. Ni-based workpieces can be made from pure Ni or Ni alloys (e.g. Alloy 400 UNS N04400, Alloy 600 UNS N06600, Alloy 625 UNS N06625, Alloy 685 N07001 (“Waspaloy”), Alloy 718 UNS N07718, Alloy X-750 UNS N07750, Alloy C-276 UNS N10276, Alloy C-22 UNS N06022, Alloy 617 UNS N06617, Nitinol, Rene alloys such as Rene 41 UNS N07041, Alloy 825 UNS N08825, Nimonic alloys such as Nimonic 90 UNS N07090, and the variants of each). As used herein, the term Ni-based alloys should be interpreted as including Ni-based single crystal alloys, including, but not limited to, RR2000, AM1, CMSX-2 through CSMX-10, PWA1484, TMS 75, and TMS 113. Co-based alloys include X-45, FSX-414, Haynes-25 UNS R30605, Haynes Ultimet UNS R31233, and Co-6 UNS R30006. As used herein, the term Co-based alloys should be interpreted as including Co-based single crystal alloys. Titanium aluminide (TiAl), commonly gamma titanium, is an intermetallic chemical compound such as one used in the low pressure turbine blade applications, alloy Ti-48Al-2Cr-2Nb.

With respect to the third workpiece material category, the workpiece is comprised of austenitic stainless steel. Austenitic stainless steels include 303 UNS S30300, 304 UNS S30400, 316L UNS S31603, Incoloy alloys such as Alloy 20 UNS N08020 and A-286 UNS S66286, Nitronic alloys such as Nitronic 40 UNS S21900 and Nitronic 60, Alloy 218 UNS S21800, Alumina-Forming Austenitic (AFA) Grade Alloys, X4CrNiMo16-5-1 EN1.4418, and X20CrMoV11-1 EN 1.4922, each of which is Ni-containing, and 420 UNS 42000, and 430 UNS 43000, each of which is absent Ni.

With respect to the fourth workpiece material category, the workpiece is comprised of martensitic stainless steel. Martensitic stainless steels include 431 UNS S43100, 17-4 PH UNS S17400, X4CrNiMo16-5-1 EN 1.4418, and X20CrMoV11-1 EN 1.4922, each of which is Ni-containing, and 420 UNS S42000, and which is absent Ni.

With respect to the fifth workpiece material category, the workpiece is comprised of ferritic stainless steel, carbon steel, or alloy steel. Ferritic stainless steels include 409 UNS S40920, 410 UNS S41000, 430 UNS S43000, 439 UNS S43035, 441 UNS S44100, 434 UNS S43400, and 436 UNS S43600 (each of which contains greater than 10.5% Cr). Carbon steels include low-carbon steel (0.05% to 0.25% carbon by volume), medium-carbon steel (0.3% to 0.5% carbon by volume), and high-carbon steel (0.6% to 1.5% carbon by volume). Carbon steel grades include A36 UNS K02600, 1018 UNS G10180, a1011 and 1020 UNS G1020, 1045 UNS G10450, and A516 UNS K02700, among others. Tool steels are a subcategory of both carbon steels and alloy steels in which the carbon steel or alloy steel has high hardness and resistance to abrasion and deformation (generally including from 0.5% to 1.5% carbon by volume). Tool steels are categorized into five groups: water-hardening tool steel, cold-working tool steel, shock-resisting tool steel, high-speed tool steel and hot-working tool steel UNS T00001 through UNS T99999.

With respect to the sixth workpiece material category, the workpiece is comprised of pure aluminum or aluminum alloys UNS A00001 through A99999. Al alloys have two principal classifications, namely casting alloys and wrought alloys. Both classifications are further subdivided into heat treatable and non-heat treatable. Wrought aluminum is identified with a four-digit number which identifies the alloying elements. Cast aluminum alloys use a four-to five-digit number with a decimal point. Among cast aluminum alloys, the digit in the hundreds place indicates the alloying elements, while the digit after the decimal point indicates the form (cast shape or ingot). All series in all product forms are considered to fall within this material category. Among wrought alloys are included 1XXX (essentially pure), 2XXX (alloyed with copper), 3XXX series (alloyed with manganese), 4XXX series (alloyed with silicon), 5XXX series (alloyed with magnesium), 6XXX series (alloyed with magnesium and silicon), 7XXX series (alloyed with zinc), 8XXX series (alloyed with other elements not covered by the other series). Among cast alloys are included 1xx.x series (minimum 99% aluminum), 2xx.x series (alloyed with copper), 3xx.x series (alloyed with silicon, copper, and/or magnesium), 4x.xx series (alloyed with silicon), 5xx.x series (alloyed with magnesium), 7xx.x series (alloyed with zinc), 8xx.x series (alloyed with tin), and 9xx.s series (alloyed with other elements not covered by the other series).

With respect to the seventh workpiece material category, the workpiece is comprised of pure copper or copper alloys. There are as many as 400 different copper and copper alloy compositions loosely grouped into the categories: copper, high copper alloy, brasses, bronzes, copper nickels, copper-nickel-zinc (nickel silver), leaded copper, and special alloys. All groups and categories are considered to fall within this metal category. Copper alloys and brass, where zinc is the principal alloying element, are referenced by UNS numbers X1xxx-C4xxxx and C66400-C69800. Phosphor bronze, where tin is the principal alloying element, are referenced by UNS numbers C5xxxx. Aluminum bronzes, where aluminum is the principal alloying element, are referenced by UNS numbers C60600-C64200. Silicon bronzes, where silicon is the principal alloying element, are referenced by UNS numbers C64700-C66100. Cupronickel/nickel silvers, where nickel in the principal alloying element, are referenced by UNS numbers C7xxxx.

Regardless of the specific workpiece material, the workpiece may be formed or produced by any method, including but not limited to wrought metal forming, casting, drawing, extrusion, super plastic forming, diffusion bonding, powder metallurgy, their sintered products and biproducts, welding, explosive bonding, spin forming, and additive manufacturing.

The electrolyte solution into which the workpiece and electrode are immersed in steps 210 and 220 generally comprises any suitable electrolyte solution whose conductivity is greater than 0.011649 micro-siemens per cm at 0° C. (ASTM D1125-95 1999). For Faraday's Laws of Electrolysis to be effective, the electrolyte solution must be able to transport any charge introduced to it. Pure water, having a conductivity of 0.011649 micro-siemens per cm at 0° C., will not support the transportation of an introduced charge, unless the driving force (voltage) is excessively large and therefore able to bridge the gap from one electrode to the other. Accordingly, the electrolyte solution used herein must have a conductivity greater than that of pure water.

The specific composition of the electrolyte solution is not limited provided it meets the previously described conductivity requirement. The specific composition of the electrolyte solution may be selected based on, for example, the material composition of the workpiece and/or electrode. For example, the exact chemical species of the electrolyte may be selected based on the metallic ions involved in the electrolysis reaction. The electrolyte solution may be aqueous or non-aqueous.

Various solutes can be included in the electrolyte composition in order to adjust the conductivity of the electrolyte solution. Elements and their compounds from the alkali, alkali earth, transition and post transition metals form excellent ionic solutes, as do halogens, metalloids, reactive non-metals and their respective salts, acids, bases and oxides. Additionally, organic compounds and their complexes such as alcohols, aldehydes, ketones, carboxylic acids, amines and others can play a beneficial role within the electrolyte. Suitable organic compounds may be water soluble or water insoluble. Surfactants may also be used in the electrolyte composition.

In some embodiments, the electrolyte is free or substantially free of nitrogen and nitrogen-containing compounds such as, but not limited to nitrates. By providing an electrolyte solution that is free or substantially free of nitrogen and nitrogen-containing compounds, the processes described herein may avoid the emission of NOₓ offgasses. It is generally desirable to avoid the emission of NOₓ offgasses due to regulatory, environmental, and health and human safety issues associated with the emission of NOₓ offgases.

In step 230, a first operational mode is initiated, in which a first type of current is applied across the electrolyte solution between the electrically conductive metal workpiece and the electrode. Generally speaking, the first type of current will either be direct current or alternating current. Either current type can be used in step 230, provided that step 240 uses the type of current not used in step 230. The method generally is not materially impacted whether alternating current or direct current is used first. As discussed in greater detail below, the first type of current applied in step 230 is maintained for a period of time, after which step 240 is carried out to terminate the first operational mode. Terminating the first operation mode generally includes terminating the application of the first type of current so that no current is applied across the electrolyte between the workpiece and the electrode.

In step 250, a second operational mode is initiated, in which a second type of current is applied across the electrolyte solution between the electrically conductive metal workpiece and the electrode. Generally speaking, the second type of current will either be direct current or alternating current, so long as the second type of current is not the same type of current as used in the first operational mode. As discussed in greater detail below, the second type of current applied in step 250 is maintained for a period of time, after which step 260 is carried out to terminate the second operational mode. Terminating the second operation mode generally includes terminating the application of the second type of current so that no current is applied across the electrolyte between the workpiece and the electrode.

For sake of simplicity, the following discussion will describe an embodiment wherein direct current is applied in the first operational mode and alternating current is applied in the second operational mode. However, as noted previously, the systems and method are not limited to this order, and in other embodiments, the first operational mode may include application of alternating current and the second operational mode may include application of direct current.

In the non-limiting embodiment where the first type of current applied in step 230 as part of the first operational mode is direct current, the direct current may be applied in singular polarity to the workpiece or electrode, or direct current may be applied at both a negative voltage and a positive voltage within a single operational mode.

In a single polarity embodiment, during the application of direct current within a given first operational mode, the voltage applied will not switch between positive and negative. That being said, the specific voltage applied may vary within a positive range or within a negative range during a first operational mode. For example, within the same operational mode, direct current may be applied for a period of time at one constant voltage and direction current may be applied for a period of time at a second constant voltage different from the first, though having the same polarity. However, in some embodiments, it is preferred that the voltage applied during a first operational mode be constant and the same value whenever direct current is applied. For example, when a first operational mode is first performed, the voltage applied may be held constant at +48V for the duration of the first operational mode, or at any time during the first operational mode when direct current is applied. At times during the first operational mode, the DC power can be interrupted (i.e., voltage to zero), but if and when the DC power is resumed during the first operational mode, the same constant voltage used previously within the first operational mode is used when direct current is again applied.

In a dual polarity embodiment, the first operational mode may employ a first constant voltage that is, for example, positive, for a first period of time, and later during the same first operational mode, employ a second constant voltage that is, for example, negative, for a second period of time. For example, a first operational mode may apply a constant +24 VDC for the first two seconds of the first operational mode and then change the voltage to a constant-12 VDC for a later two second period of the first operational mode.

In some embodiments, the operating voltage for direct current power ranges from about −480 VDC to about +480 VDC (inclusive of all values contained therebetween). In some embodiments, a range of from +50 VDC to +240 VDC, or from −50 VDC to −240 VDC is used. The applied voltage, in conjunction with the physical attributes of the workpiece and electrode, together with the electrolyte, will create a resultant current flow or amperage that would be readily understood by those of ordinary skill in the art.

As noted previously, the duration of the constant voltage from the DC power supply can be applied continuously or in two or more intermediate segments during a given first operational mode. When intermediate segments are used, the duration of the segments may be as short as 1 millisecond in duration. The intermediate segments may also be constant or variable in length, and the intermediate segments can be symmetrically applied or disproportionately cycled. When direct current is applied continuously during the entirety of the first operational mode, the duration of the entire first operational mode may be as short as 1 millisecond in duration.

When a first operational mode is repeated after termination of a second operational mode, the subsequent first operational mode may use the same operating parameters as the preceding first operational mode or may use one or more different operating parameters. In an example of a subsequent first operational mode using the same operational parameters as a preceding first operational mode, both the preceding first operational mode and the subsequent first operational mode may employ a constant voltage of +48 VDC for the entire duration of the respective first operational mode. In an example of a subsequent first operational mode using different operational parameters from a preceding first operational mode, the preceding first operational mode may employ a constant voltage of +24 VDC for the entire duration of the preceding first operational mode, while the subsequent first operational mode may employ a constant voltage of +48 VDC, with the voltage being applied in two intermediate segments having a break (i.e., a time period when the voltage remains at zero) between the two segments.

Following termination of the first operational mode at step 240, a second operational mode is initiated at step 250, the second operational mode employing alternating current in this embodiment. As used herein, alternating current is intended to mean that the slope of the alternating current waveform (voltage vs. time) is always changing. As such, a step wise change in voltage that generally mimics alternating current is not considered to fall within the meaning of alternating current as used herein, since the step wise waveform will include instances when the slope is not changing.

The shape of the wave form for the alternating current applied in step 250 is generally not limited provided the above provision regarding constantly changing slope is satisfied. In some embodiments, the alternating current is applied as a symmetrical sinusoidal waveform having a constant maximum voltage, though other waveform shapes can be used, including, but not limited to, complex wave, “camel hump” wave, and other irregular and/or asymmetric wave shapes.

Regardless of the wave form shape, the voltage range for the alternating current varies within the range of from about −480 VAC to about +480 VAC (inclusive of all values contained therebetween). In embodiments where a symmetrical sinusoidal waveform is used, the constant maximum voltage may be from greater than 0 VAC to about +480 VAC. The alternating current used need not switch polarity. For example, all values in the alternating current waveform may be above 0 VAC or below 0 VAC.

Another parameter of the alternating current that can be controlled is the frequency. In some embodiments, the alternating current has a frequency in the range of from about 6 Hz to about 600 MHz. Frequency can be applied symmetrically or disproportionately cycled.

The duration of the voltage from the AC power supply can be applied continuously or in two or more intermediate segments during a given second operational mode. When intermediate segments are used, the duration of the segments may be as short as 1 millisecond in duration. The intermediate segments may also be constant or variable in length, and the intermediate segments can be symmetrically applied or disproportionately cycled. When alternating current is applied continuously during the entirety of the second operational mode, the duration of the entire second operational mode may be as short as 1 millisecond in duration.

When a second operational mode is repeated after termination of a first operational mode, the subsequent second operational mode may use the same operating parameters as the preceding second operational mode or may use one or more different operating parameters. In an example of a subsequent second operational mode using the same operational parameters as a preceding second operational mode, both the preceding second operational mode and the subsequent second operational mode may employ symmetrical sinusoidal alternating current having a constant maximum value of +48 VAC with the same frequency for the entire duration of the respective second operational mode. In an example of a subsequent second operational mode using different operational parameters from a preceding second operational mode, the preceding second operational mode may employ symmetric sinusoidal alternating current having a constant maximum voltage of +48 VAC for the entire duration of the preceding second operational mode, while the subsequent second operational mode may employ a symmetrical sinusoidal alternating current having a constant maximum voltage of +24 VAC, with the voltage being applied in two intermediate segments having a break (i.e., a time period when the voltage remains at zero) between the two segments. The preceding second operational mode and the subsequent second operational mode can also vary in one or more of waveform shape, amplitude, wavelength, and frequency.

While the preceding paragraph discusses changes in the alternating current between a preceding second operational mode and a subsequent second operational mode, it should be appreciated that one or more of the alternating current waveform shape, amplitude, wavelength and frequency can be changed within a second operational mode. For example, a second operational mode may employ a symmetric sinusoidal waveform during a first part of a second operational mode, but halfway through the second operational mode, the amplitude of the sinusoidal waveform may increase or decrease.

In one particular embodiment, the initial first operational mode employs a constant direct current at a first voltage for the duration of the initial first operational mode, and each subsequent first operational mode employs a constant direct current at a voltage that increases with every additional first operational mode. For example, the initial first operational mode employs a constant voltage of +3 VDC, the next first operational mode employs a constant voltage of +6 VDC, the next first operational mode employs a constant voltage of +9 VDC, and so on. In concert with this increasing direct current voltage during the first operational modes, the corresponding second operational modes between first operational modes and which employ alternating current may use symmetric sinusoidal waveforms having progressively increasing maximum voltages. For example, the initial second operational mode following the initial first operational mode may employ alternating current using a symmetrical sinusoidal waveform having a maximum voltage of +3 VAC, the next second operational mode employs a maximum voltage of +6 VAC, the next second operational mode employs a maximum voltage of +9 VAC, and so on.

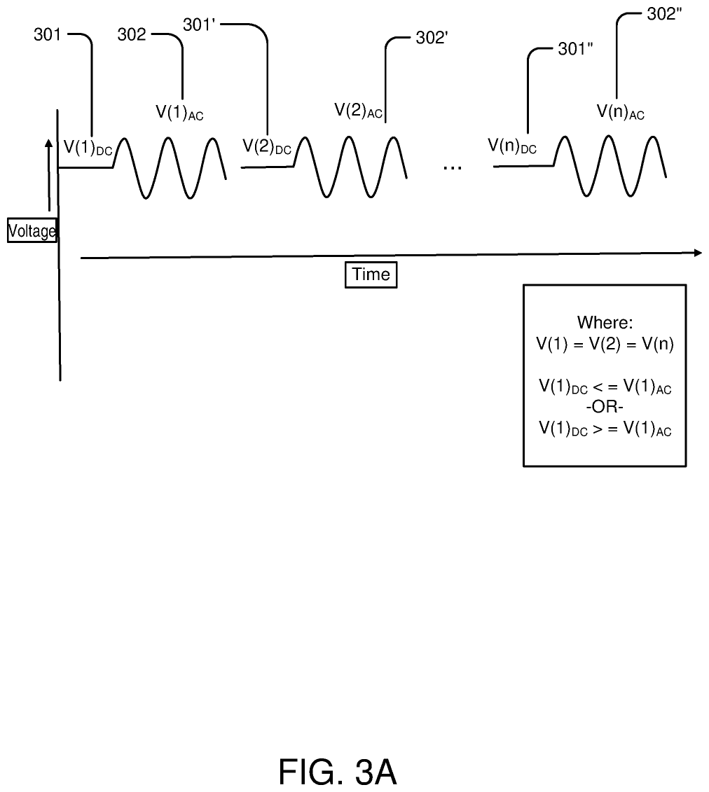

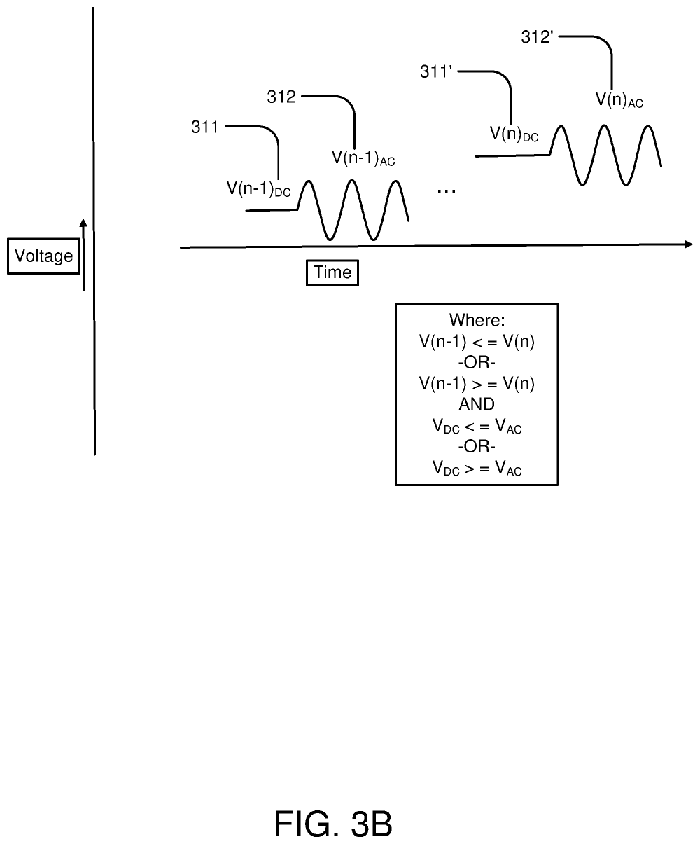

With reference now to FIGS. 3A and 3B, these graphs Illustrate various operational schemes that can be used for the methods and systems described herein. FIG. 3A illustrates an operational scheme wherein the initial first operational mode and all subsequent first operational modes use the same operating parameters, and the initial second operational mode and all subsequent second operational modes use the same operating parameters. More specifically, initial first operational mode 301 and subsequent first operational modes 301′ and 301″ all apply direct current at the same constant voltage for the duration of each first operational mode, with each first operational mode having the same time period, while initial second operational mode 302 and subsequent second operational modes 302′ and 302″ all apply alternating current using a symmetric sinusoidal waveform having the same maximum voltage, frequency, and wavelength, and each second operational mode being performed for the same period of time.

FIG. 3B illustrates another embodiment of an operational scheme that can be used wherein the constant voltage of the direct current applied in each first operational mode increases with each subsequent first operational mode and the maximum voltage of the symmetric sinusoidal waveform used when applying alternating current in the second operational mode increases with each subsequent second operational mode. More specifically, initial first operational mode 311 applies direct current at a first voltage, and first subsequent first operational mode 311′ (and all subsequent first operational modes thereafter) applies direct current at a second voltage that is either equal to, greater than, or less than the first voltage. The time period for each first operational mode is the same and the direct current is applied for the duration of each first operational mode. Meanwhile, the initial second operational mode 312 applies alternating current using a symmetric sinusoidal waveform having a first maximum voltage, and first subsequent second operational mode 312′ (and all subsequent second operational modes thereafter) applies alternating current using a symmetric sinusoidal waveform having a second maximum voltage that is either equal to, greater than, or less than the first maximum voltage. All other operating parameters for the second operational mode (e.g., duration of the second operational mode, frequency, wavelength, etc.) are the same.

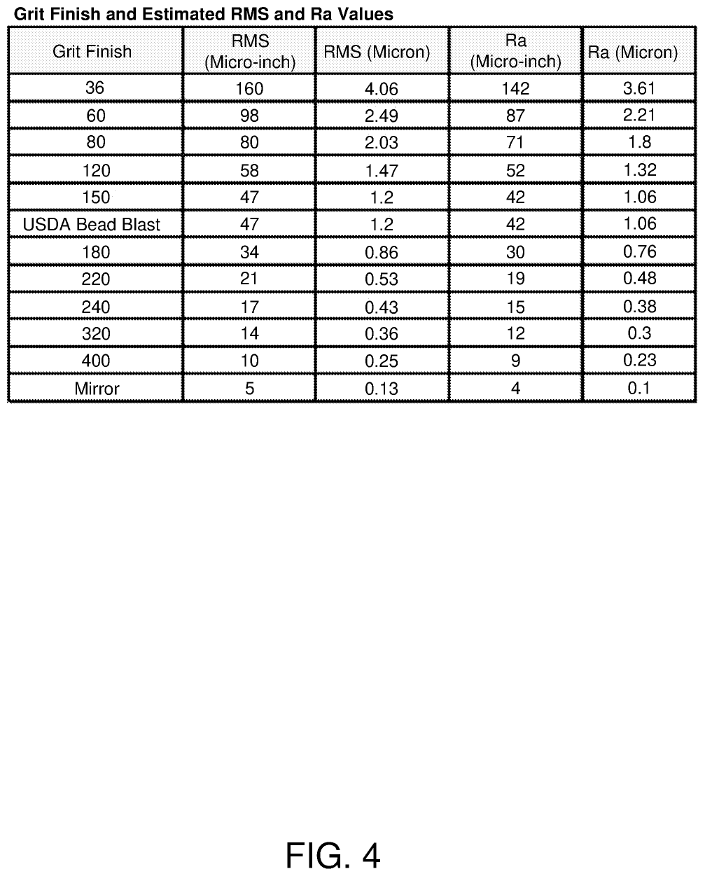

As described previously, the methods and systems described herein may be beneficially used to affect the surface of an electrically conductive metal workpiece. The term “affect” as used herein is intentionally broad, as the methods described herein may entail either deposition of material on or removal of material from the workpiece. Measurement of this improvement can be made via a surface profilometer. In some embodiments, a reduction in surface finish measurements from 1 Ra to 500 Ra is achieved. FIG. 4 provides a table associating Ra values to industry established grit values (such as are used in classifying sandpaper). With respect to beneficially affecting the surface of the workpiece via the removal of material therefrom, it should be appreciated that removal of material from the surface of the workpiece includes (but is not limited to) the use of the systems and methods described herein to perform electrochemical acid pickling (or its functional equivalent) and chemical milling (or its functional equivalent). Measurement of the improvement in the surface of the workpiece when using embodiments of the systems and methods described herein for carrying out electrochemical acid pickling and chemical milling (or their functional equivalent) can be done via thickness or gauge measurements with tools such as micrometers or ultrasonic thickness gauges. In some embodiments, precise reduction in gauge from 0.0005″ to 0.5000″ or greater is achieved.

In some embodiments, the beneficial effect on surface morphology resulting from the systems and methods described herein is the creation of localized variations in surface morphology. The specific type of localized variation in surface morphology is generally not limited, and may include any type of difference in surface morphology from the remainder of the workpiece. Exemplary, though non-limiting, localized variations in surface morphology that may be created by the systems and methods described herein include the presence of crystals in confined areas on the workpiece, and the creation of localized markings identifiable by changes in colors (e.g., black lines formed on specific portions the workpiece).

Localized variations in surface morphology such as those described above may be beneficial in that they generally signify the existence of an anomaly in the workpiece proximate the local variation. The specific anomaly associated with the local variation in surface morphology is generally not limited, and may include, e.g., a change in surface chemistry, or the presence of sub-surface defects, such as sub-surface voids. Identifying these local variations (which may be treated as “markers”) on the workpiece can result in opportunities for subsequent remedial or beneficial processing of the workpiece (e.g., mechanical polishing). As a result, the system 100 described herein may be expanded to include one or more devices capable of identifying these local variations in surface morphology to thereby identify opportunities for further workpiece processing. Any devices suitable for identifying the localized variations can be used, such as optical scanners.

Furthermore, it should be appreciated that the beneficial effect obtained by the methods and systems described herein may not include a change in surface morphology. For example, the beneficial affect obtained may relate to a change in surface chemistry of the workpiece. For example, passivation of stainless steels occurs when the surface is purged of extraneous iron, and a barrier layer of metallic oxides are reinforced on the surface of the metallic species. No measurable improvement in surface finish is realized in this instance, but the change in surface chemistry still provides a benefit to the workpiece. Thus, beneficially affecting the workpiece via a change in surface chemistry can include, e.g., removing metallic material, adding oxygen (e.g., via formation of an oxide layer), removing hydrogen, preventing or inhibiting the attachment of hydrogen, or any combination thereof.

In some embodiments, the beneficial effect on the surface of an electrically conductive metal workpiece resulting from the systems and methods described herein is charging at least the surface of the metal workpiece with hydrogen. In this manner, the metal workpiece can be used for hydrogen storage, which may be beneficial for applications in which hydrogen is used as an energy source. When charging the metal workpiece with hydrogen using the methods and systems described herein, the surface and the portions of interior of the workpiece may be charged with hydrogen. For example, hydrogen may be stored on the surface of the workpiece and along grain boundaries located within the metal workpiece.

While not shown in FIG. 1, other process parameters may be adjusted and/or manipulated as part of system 100 to improve the performance of the methods described herein. In one example, the thermal activity of the electrolyte may be an important component of molecular activity and may therefore be controlled to have an impact on the ability of the electrolyte to transport electrical charge. In some embodiments, the electrolyte solution used in system 100 described herein operates within the operating range of from about 10° C. to about 100° C. In some embodiments, the processes described herein are carried out at a controlled processing temperature, though the temperature may be controlled (e.g., elevated above room temperature) as a means for speeding up the desired electrochemical reactions. The addition of heat to the system 100 in order to speed up the electrochemical reactions can be provided by heating device 170 described previously. In other embodiments, the processes described herein are carried out a while the temperature may be controlled at a reduced processing temperature as a means of reducing the desired electrochemical reactions provided by a cooling device 170 prescribed previously. Precise control of the heating device 170 thereby allows for precise control of the electrochemical reactions and surface treatments. This precise control of the processing temperature and corresponding precise control over the electrochemical reactions thereby allows the system and processes to operate without need for, e.g., limited loads, costly chillers and/or hold times that are often required with other surface treatment processes, such as pickling.

Additionally, other externally applied physical forces can be advantageous to the overall performance of the systems and methods described herein. As mentioned previously, the mixing rate of the electrolyte can have significant impact on the thin barrier layer adjacent to the electrode(s). Thus, in some embodiments of the system 100 described herein, additional steps are taken to mix the electrolyte during the above-described processes. Mixing may be carried out by any suitable means, including either via physical or thermal mixing. Pumps, mixers, spargers, devices configured for moving the workpiece and/or electrode, specific fluid delivery methods and others in combination with heat transfer mechanisms and chemical reactions that are both exothermic and endothermic may all have their respective beneficial impact on the result of the electrolysis reactions.

In some embodiments, one or more of any of the various operating parameters discussed previously with respect to operation of the system 100 can be controlled, adjusted and/or manipulated in such a manner as to control the barrier layer formed on the workpiece and/or electrode. The operating parameters of system 100 that can be controlled for the purpose of controlling the barrier layer can pertain to chemical, mechanical, electrical, magnetic, and/or molecular excitation operating parameters. The control of the barrier layer can pertain to, for example, controlling the thickness of the barrier layer, controlling the chemical composition of the barrier layer, and/or any other aspects of the barrier layer. Controlling the operating parameters of the system 100 in such a way as to control the barrier layer beneficially allows for control of the availability or lack of availability of disassociated ion species deriving from constituents of the electrolyte. This in turn allows for precise control over the chemical reactions involved in the electrochemical processes described herein and therefore precise control over the manner in which the surface of the workpiece is beneficially affected. This may be in stark contrast to other previously known methods for altering the surface of a workpiece, such as pickling, which is notoriously difficult to control due to, e.g., exothermic reactions that occur as part of the pickling process and which cause the reactions to proceed at increasingly rapid and uncontrolled rates.

In some embodiments, the system 100 further includes one or more pieces of equipment configured to automatically monitor, analyze and/or adjust one or more operating parameters that can be used to control the barrier layer, which in turn allows this equipment to control the manner in which the workpiece is beneficially affected. The equipment may be programmed with computer-implemented instructions that thereby allows for automatic control of the systems and processes described herein to obtain a desired outcome for the workpiece. That is to say, human intervention may not be required when the operating parameters are automatically monitored, analyzed and adjusted by the additional equipment to obtain the desired result for the workpiece. Such equipment may generally operate based on known relationships between various operating parameters and their associated impact on the barrier layer, and further aids in providing highly repeatable processes achieving identical or near identical results for each individual workpiece processed using the technology described herein.

In view of the various manners of precisely controlling the operation of the system 100 and precisely carrying out the method 200 described herein, the technology described herein is highly repeatable. A single set of precise operating parameters can be used to repeatedly and reliably obtain identical or practically identical results for the same workpiece, electrode and/or electrolyte combinations.

One of the benefits provided by the systems and methods described herein is the ability to closely control surface affects at the extremes of material types. For example, aluminum is generally considered a metal material that is remarkably easy to attack, thus making close control of material removal (e.g., removing very small amounts of material) difficult. However, using the systems and methods described herein, it is possible to gently polish the aluminum. Similarly, niobium is generally considered a metal material that is remarkably difficult to attack, thus making relatively large removal of material difficult. However, using the systems and methods described herein, it is possible to aggressively remove niobium.

### EXPERIMENTAL RESULTS

In some of the experiments described below, reference is made to a color chart documented by the Massachusetts Institute of Technology (MIT). This color chart presents interference colors exhibited by reactive metals having relatively thin surface oxide layers formed thereon as a function of dissociation voltage. When the surface oxide layers are relatively thin (30-150 nm), they interfere with light, creating a perception of color to the human eye. These interference colors are a function of the oxide's thickness. This process is typically performed via DC electrolysis, resulting when the metal is anodically charged in a conductive electrolyte. When water is disassociated, nascent oxygen bonds to the anodic metal electrode. These oxides are highly resistive to electric current resulting in the need to increase the electrical potential of the circuit to grow the thickness of the oxide.

### Workpiece Material Category 1—Reactive Metals

### Experiment 1

In an aqueous electrolyte comprised of citric acid (15 g/L) and ammonium bifluoride (8 g/L) at 66° C., a coupon of Niobium was acted upon by a Bimodal A/C and D/C power supply configured in accordance with the embodiments described herein. The operational scheme for this experiment provided 60 Hz of alternating current at 24 volts (maximum voltage using symmetric sinusoidal waveform) for 15 seconds, followed by direct current at 24 volts for 15 seconds, and repeated these two operational modes 5 times for a total operation time of 2.5 minutes. At the completion of the cycle, the material realized a gage reduction of 0.074 inches per minute and a moderate improvement of surface finish of 5%.

### Experiment 2

In an aqueous electrolyte comprised of citric acid (30 g/L) and ammonium bifluoride (10 g/L) at 66° C., a coupon of nuclear grade zirconium alloy Zr-2.5Nb (UNS R60901) was acted upon by a Bimodal A/C and D/C power supply configured in accordance with the embodiments described herein. The operational scheme for this experiment provided 60 Hz of alternating current at 24 volts (maximum voltage using symmetric sinusoidal waveform) for 15 seconds, followed by direct current at 24 volts for 15 seconds, and repeated these two operational modes 5 times for a total operation time of 2.5 minutes. At the completion of the cycle, the material realized a gage reduction of 0.056 inches per minute and a reduction of surface finish of 24%.

### Experiment 3

In an aqueous electrolyte comprised of 150 g/l of Magnesium Chloride at 40° C., a coupon of commercially pure titanium (Ti-CP, UNS R50400) was acted upon by a Bimodal A/C and D/C power supply configured in accordance with the embodiments described herein. The operational scheme for this experiment provided alternating current at 6 Hz at 3 volts (maximum voltage using symmetric sinusoidal waveform) for 15 seconds, followed by direct current at 3 volts for 15 seconds, and repeated these two operational modes 5 times, increasing the voltage for both the alternating current mode and the direct current mode by 3 volts for the second pairing and by 6 volts for each of the third, fourth, and fifth pairing until reaching 24 volts in both the alternating current mode and the direct current mode in the final pairing. The total operation time was 2.5 minutes. This resulted in an oxide growth equivalent to the thickness demonstrated by the MIT chart of a conventional 50 VDC process. OSHA regulations in 29 CFR 1910.303(g)(2)(i) require guarding of exposed electric equipment at 50 volts or less, whether generated by alternating or direct methods. Providing a conventional outcome at lower operating voltages provides substantial operating benefits to workers exposed to operating conditions.

### Experiment 4

In an aqueous electrolyte comprised of 50 g/L of Sodium Bisulfate, 150 g/L of Magnesium Chloride at 50° C., a coupon of aerospace grade titanium (Ti-6Al-4V, UNS R56400) was acted upon by a Bimodal A/C and D/C power supply configured in accordance with the embodiments described herein. The operational scheme for this experiment provided alternating current at 6 Hz at 3 volts (maximum voltage using symmetric sinusoidal waveform) for 15 seconds, followed by direct current at 3 volts for 15 seconds, and repeated these two operational modes 5 times, increasing the voltage for both the alternating current mode and the direct current mode by 3 volts for the second pairing and by 6 volts for each of the third, fourth, and fifth pairing until reaching 24 volts in both the alternating current mode and the direct current mode in the final pairing. The total operation time was 2.5 minutes. This resulted in an oxide growth equivalent to the thickness demonstrated by the MIT chart of a conventional 115 VDC process, thereby reducing the operating voltage almost 5-fold.

### Experiment 5

In an aqueous electrolyte comprised of 30 g/L of Citric Acid, 10 g/L of Ammonium Bifluoride at 45° C., a coupon of aerospace grade titanium (Ti-6Al-4V, UNS R56400) covered in mill scale was acted upon by a Bimodal A/C and D/C power supply configured in accordance with the embodiments described herein. The operational scheme for this experiment provided 5 Hz of alternating current at 24 volts (maximum voltage using symmetric sinusoidal waveform) for 15 seconds, followed by direct current at 24 volts for 15 seconds, and repeated these two operational modes 360 times for a total operation time of 180 minutes. Mill scale of titanium is a heavy oxide that exhibits ceramic like properties of hardness and corrosion resistance. Conventional processing requires an abrasive media blast or other machine tool to either crack the oxide such that hydrofluoric acid can impregnate the oxide and undercut the chemically inert material to remove it from the metal surface or remove it altogether. Without affecting the scale prior to processing, irregular removal of the scale occurs such that once fully removed, the underlying material undergoes selective and inconsistent removal resulting in a rough and often times pitted surface. The coupon in this trial was not subject to any preprocessing whatsoever. The scaled material was subjected directly to electrochemical operation, and at the end of the cycle, was free of oxide and materially sound. A uniformly smooth surface. To achieve this result only by electrochemical methods is remarkably significant.

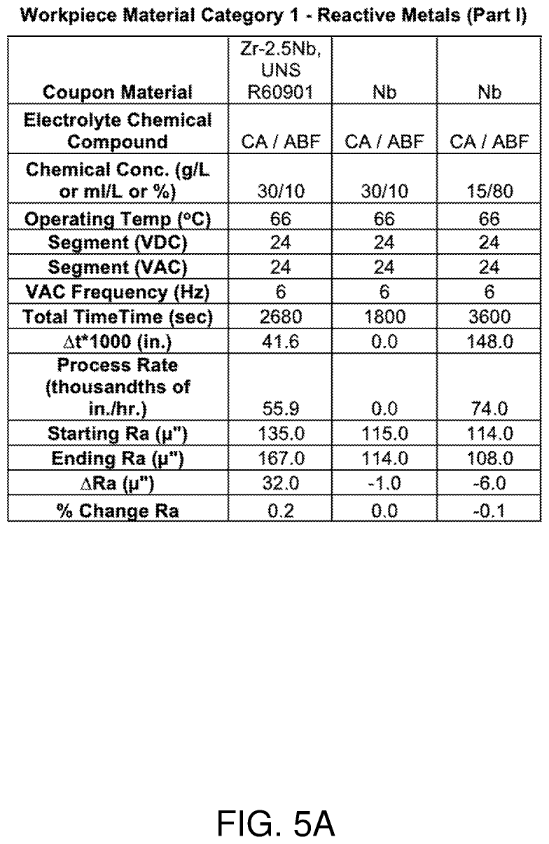

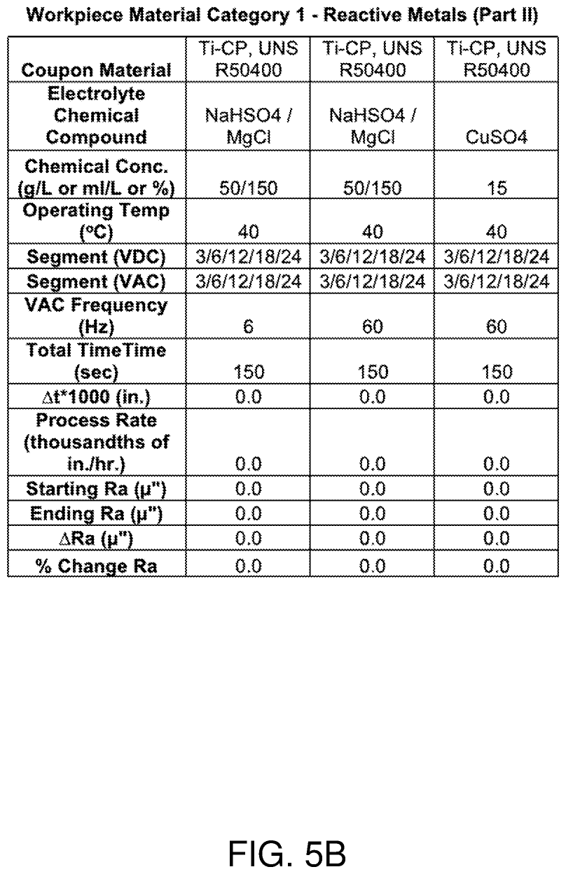

Additional data pertaining to the above experiments and additional experiments carried out on reactive metals is set forth in the tables presented in FIGS. 5A and 5B.

### Workpiece Material Category 2—High Temperature/High Strength Metals

### Experiment 6

In an aqueous electrolyte comprised of citric acid (30 g/L) and ammonium bifluoride (10 g/L) at 66° C., a coupon of nitinol nickel-titanium alloy (Ni-45Ti, UNS N01555) was acted upon by a Bimodal A/C and D/C power supply configured in accordance with the embodiments described herein. The operational scheme for this experiment provided 60 Hz of alternating current at 24 volts (maximum voltage using symmetric sinusoidal waveform) for 15 seconds, followed by direct current at 24 volts for 15 seconds, and repeated these two operational modes 5 times for a total operation time of 2.5 minutes. At the completion of the cycle, the material realized an improvement of surface finish of 12% while undergoing a gage reduction of 0.037 inches per hour.

### Experiment 7

In an aqueous electrolyte comprised of fluorboric acid (50 wt. %) at 50 ml/L and 40° C., a heat-treated coupon of austenitic alloy C22 (UNS N06022, Ni-22Cr-13Mo-3Fe-3 W) was acted upon by a Bimodal A/C and D/C power supply configured in accordance with the embodiments described herein. The operational scheme for this experiment provided alternating current at 6 Hz at 3 volts (maximum voltage using symmetric sinusoidal waveform) for 15 seconds, followed by direct current at 3 volts for 15 seconds, and repeated these two operational modes 5 times, increasing the voltage for both the alternating current mode and the direct current mode by 3 volts for the second pairing and by 6 volts for each of the third, fourth, and fifth pairing until reaching 24 volts in both the alternating current mode and the direct current mode in the final pairing. The total operation time was 2.5 minutes. At the completion of the cycle, the material was oxide free and smooth, experiencing a reduction in surface finish of 13%, while undergoing a gage reduction of 0.019 inches per hour.

### Experiment 8

In an aqueous electrolyte comprised of fluorboric acid (50 wt. %) at 50 ml/L and 40° C., a heat-treated coupon of nickel alloy Nimonic Alloy 90 (UNS N07090, Ni-20Cr-16Co-3Ti-2Al) was acted upon by a Bimodal A/C and D/C power supply configured in accordance with the embodiments described herein. The operational scheme for this experiment provided alternating current at 6 Hz at 3 volts (maximum voltage using symmetric sinusoidal waveform) for 15 seconds, followed by direct current at 3 volts for 15 seconds, and repeated these two operational modes 5 times, increasing the voltage for both the alternating current mode and the direct current mode by 3 volts for the second pairing and by 6 volts for each of the third, fourth, and fifth pairing until reaching 24 volts in both the alternating current mode and the direct current mode in the final pairing. The total operation time was 2.5 minutes. At the completion of the cycle, the material was smooth, experiencing a reduction in surface finish of 19%, while undergoing a gage reduction of 0.019 inches per hour.

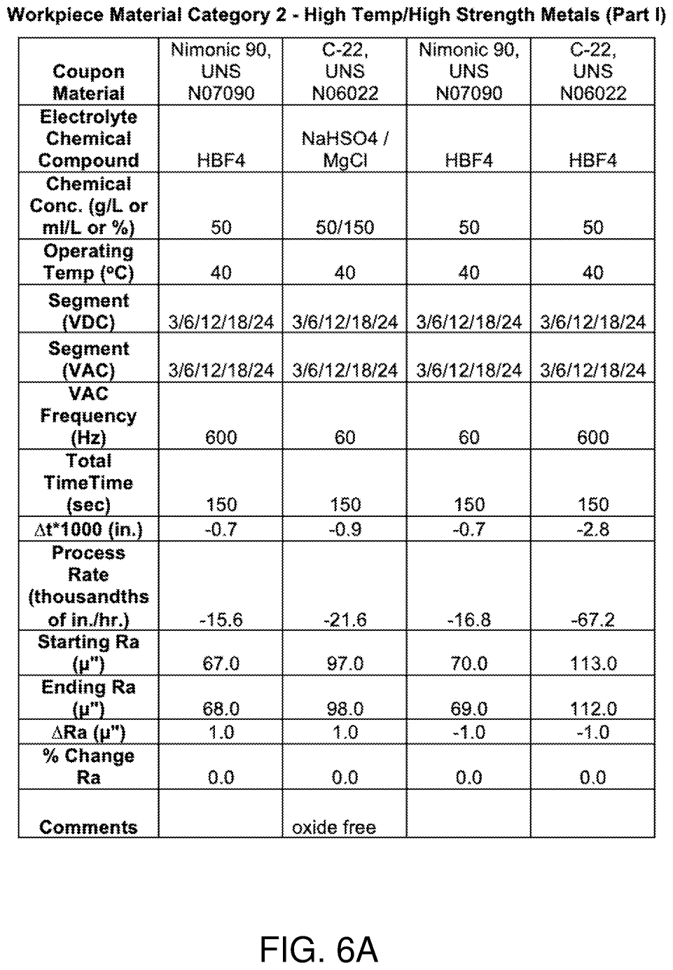

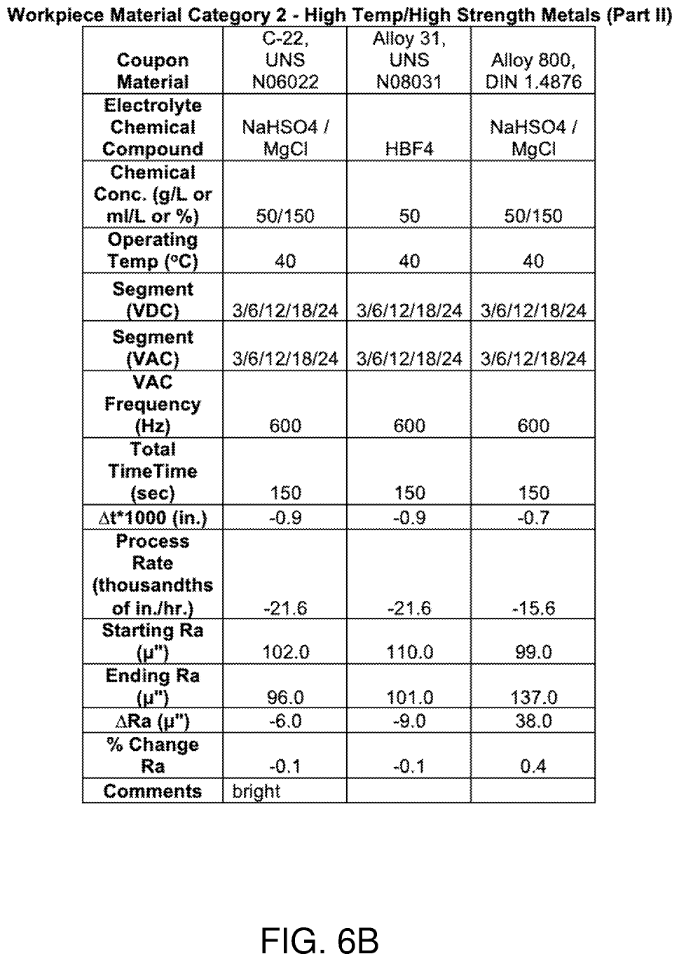

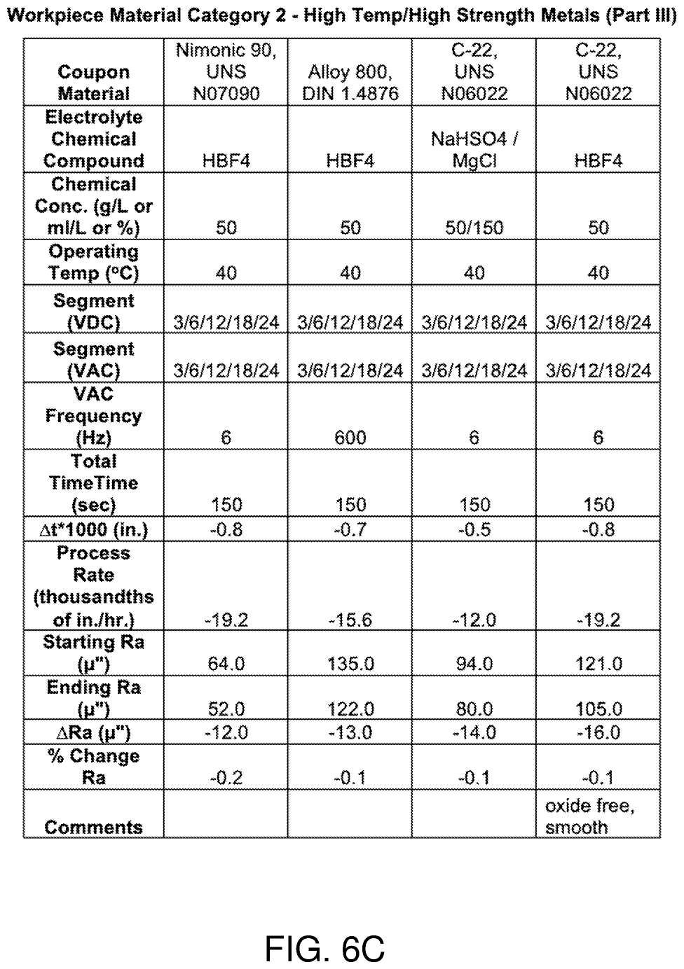

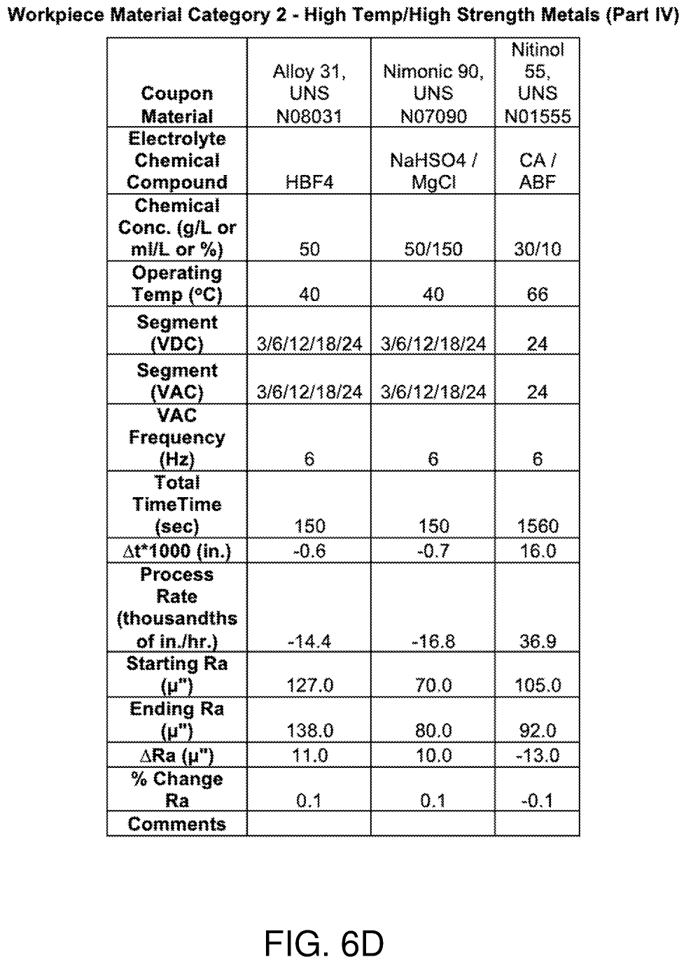

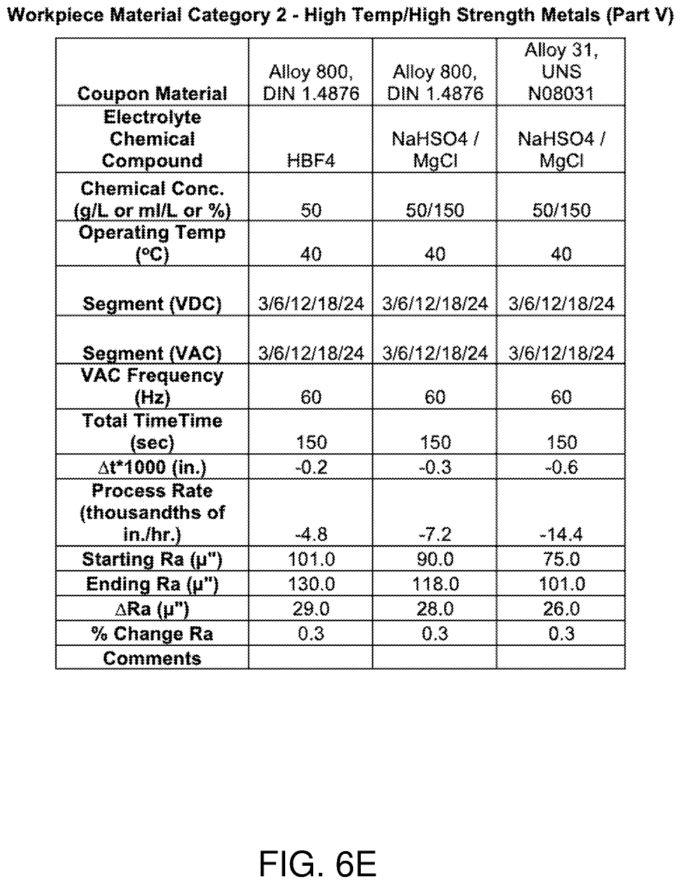

Additional data pertaining to the above experiments and additional experiments carried out on high temperature/high strength alloys is set forth in the tables presented in FIGS. 6A-6E.

### Workpiece Material Category 3—Austenitic Stainless Steel

### Experiment 9

In an aqueous electrolyte comprised of sodium bisulfate (50 g/L) and magnesium chloride (150 g/L) at 40° C., a heat-treated coupon of austenitic creep resisting steel alloy X20CrMoC11-1 (DIN 1.4922, Fe-11Cr-1Mo-1Ni-1Mn) was acted upon by a Bimodal A/C and D/C power supply configured in accordance with the embodiments described herein. The operational scheme for this experiment provided alternating current at 60 Hz at 3 volts (maximum voltage using symmetric sinusoidal waveform) for 15 seconds, followed by direct current at 3 volts for 15 seconds, and repeated these two operational modes 5 times, increasing the voltage for both the alternating current mode and the direct current mode by 3 volts for the second pairing and by 6 volts for each of the third, fourth, and fifth pairing until reaching 24 volts in both the alternating current mode and the direct current mode in the final pairing. The total operation time was 2.5 minutes. At the completion of the cycle, the material experienced a reduction in surface finish of 2%, while undergoing a gage reduction of 0.034 inches per hour.

### Experiment 10

In an aqueous electrolyte comprised of fluorboric acid (50 wt. %) at 50 ml/L and 40° C., a heat-treated coupon of austenitic stainless steel alloy Nitronic 50 (XM-19, UNS S20910, Fe-21Cr-13Ni-5Mn-3Mo-0.3N-0.2Nb) was acted upon by a Bimodal A/C and D/C power supply configured in accordance with the embodiments described herein. The operational scheme for this experiment provided alternating current at 600 Hz at 3 volts (maximum voltage using symmetric sinusoidal waveform) for 15 seconds, followed by direct current at 3 volts for 15 seconds, and repeated these two operational modes 5 times, increasing the voltage for both the alternating current mode and the direct current mode by 3 volts for the second pairing and by 6 volts for each of the third, fourth, and fifth pairing until reaching 24 volts in both the alternating current mode and the direct current mode in the final pairing. The total operation time was 2.5 minutes. At the completion of the cycle, the material was free of the heat-treating oxide, was bright and smooth, experiencing a reduction in surface finish of 23% and a minimal gage reduction of 0.0024 inches per hour.

### Experiment 11

In an aqueous electrolyte comprised of fluorboric acid (50 wt. %) at 50 ml/L and 40° C., a heat-treated coupon of austenitic stainless steel alloy 316L (UNS S31603, Fe-18Cr-15Ni-3Mo-2Mn) was acted upon by a Bimodal A/C and D/C power supply configured in accordance with the embodiments described herein. The operational scheme for this experiment provided alternating current at 60 Hz at 3 volts (maximum voltage using symmetric sinusoidal waveform) for 15 seconds, followed by direct current at 3 volts for 15 seconds, and repeated these two operational modes 5 times, increasing the voltage for both the alternating current mode and the direct current mode by 3 volts for the second pairing and by 6 volts for each of the third, fourth, and fifth pairing until reaching 24 volts in both the alternating current mode and the direct current mode in the final pairing. The total operation time was 2.5 minutes. At the completion of the cycle, the material was free of the heat-treating oxide, was bright and smooth, experiencing a reduction in surface finish of 26% and a minimal gage reduction of 0.0048 inches per hour.

### Experiment 12

In an aqueous electrolyte comprised of fluorboric acid (50 wt. %) at 50 ml/L and 40° C., a heat-treated coupon of boron alloyed austenitic 304 stainless steel (UNS S30463, Fe-19Cr-13Ni-2B) was acted upon by a Bimodal A/C and D/C power supply configured in accordance with the embodiments described herein. The operational scheme for this experiment provided alternating current at 60 Hz at 3 volts (maximum voltage using symmetric sinusoidal waveform) for 15 seconds, followed by direct current at 3 volts for 15 seconds, and repeated these two operational modes 5 times, increasing the voltage for both the alternating current mode and the direct current mode by 3 volts for the second pairing and by 6 volts for each of the third, fourth, and fifth pairing until reaching 24 volts in both the alternating current mode and the direct current mode in the final pairing. The total operation time was 2.5 minutes. At the completion of the cycle, the material was free of the heat-treating oxide, was bright and smooth, experiencing a reduction in surface finish of 5% and a minimal gage reduction of 0.0144 inches per hour.

### Experiment 13

In an aqueous electrolyte comprised of sodium bisulfate (50 g/L) and magnesium chloride (150 g/L) at 40° C., a heat-treated coupon of austenitic 303 stainless steel (UNS S30300, Fe-18Cr-9Ni-1.8 Mn-0.25S) was acted upon by a Bimodal A/C and D/C power supply configured in accordance with the embodiments described herein. The operational scheme for this experiment provided alternating current at 60 Hz at 3 volts (maximum voltage using symmetric sinusoidal waveform) for 15 seconds, followed by direct current at 3 volts for 15 seconds, and repeated these two operational modes 5 times, increasing the voltage for both the alternating current mode and the direct current mode by 3 volts for the second pairing and by 6 volts for each of the third, fourth, and fifth pairing until reaching 24 volts in both the alternating current mode and the direct current mode in the final pairing. The total operation time was 2.5 minutes. At the completion of the cycle, the material realized a moderate gage reduction of 0.043 inches per hour.

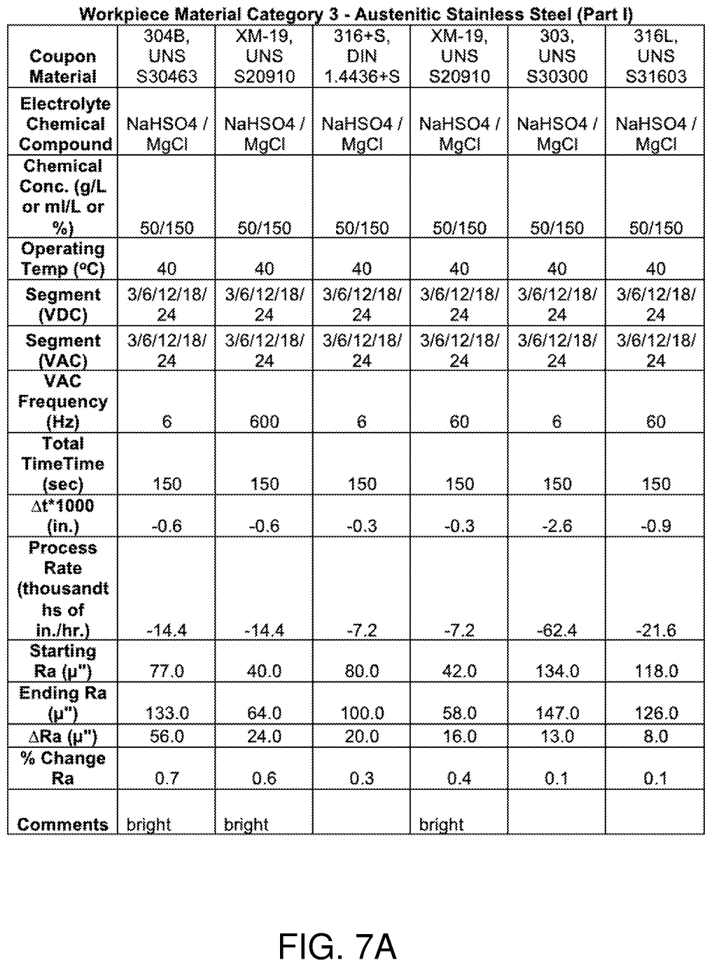

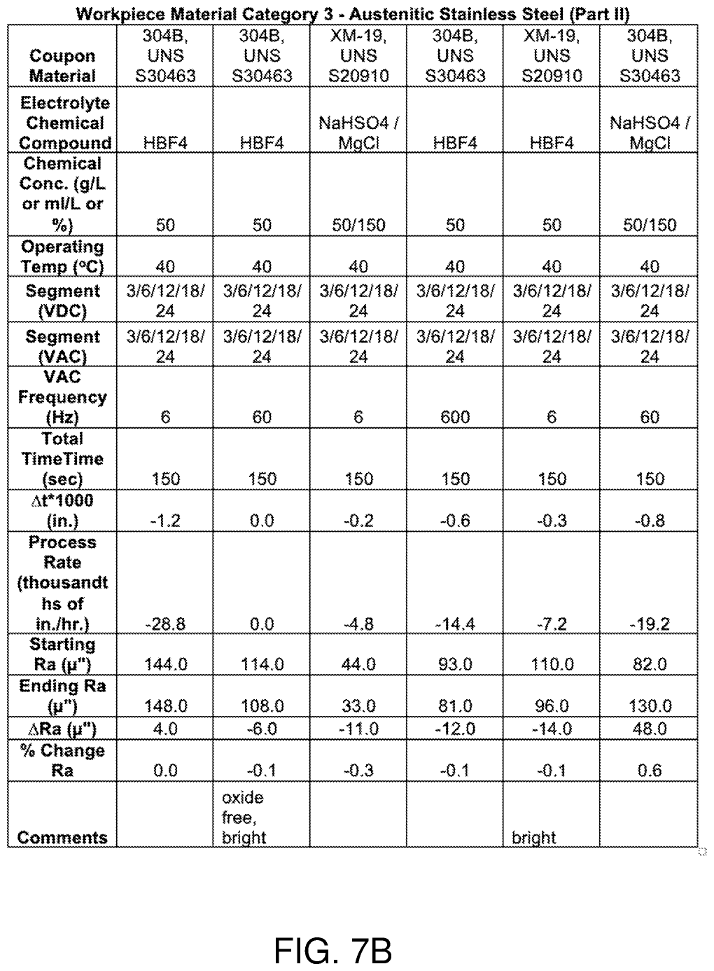

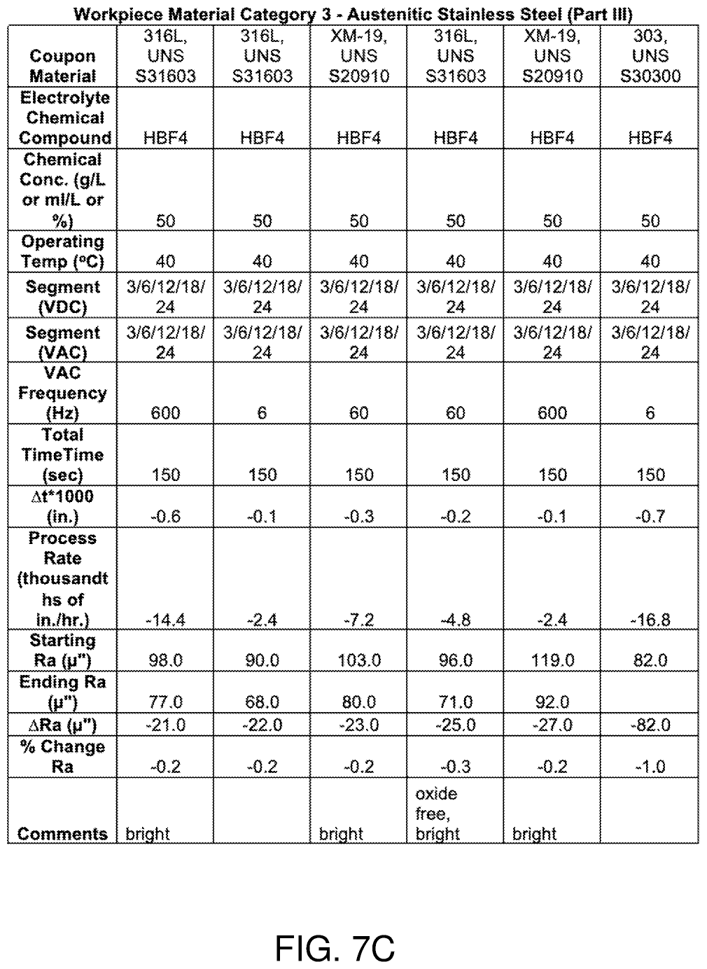

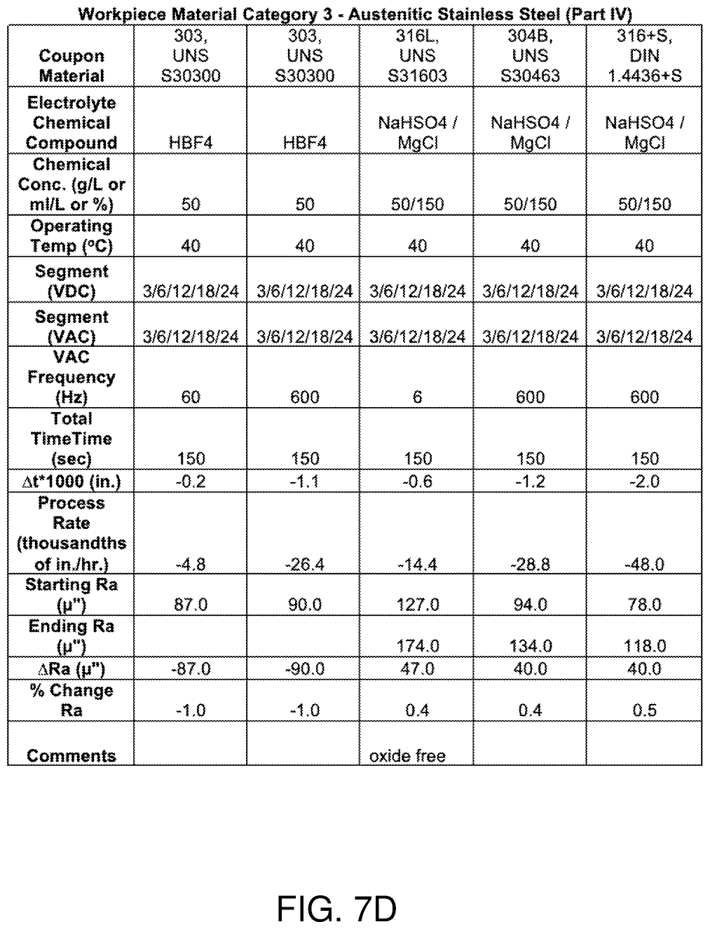

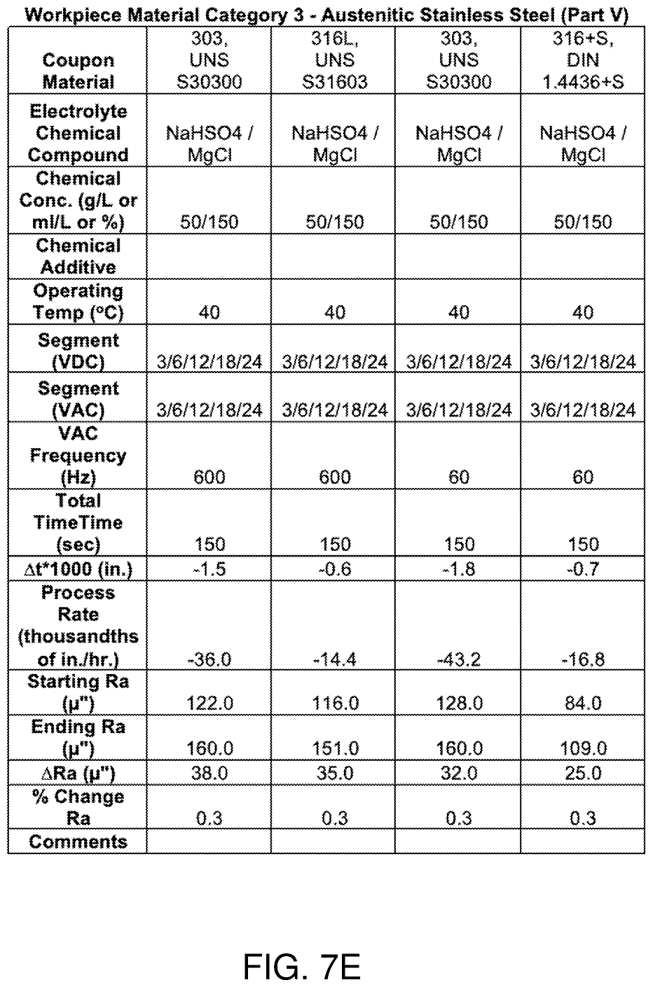

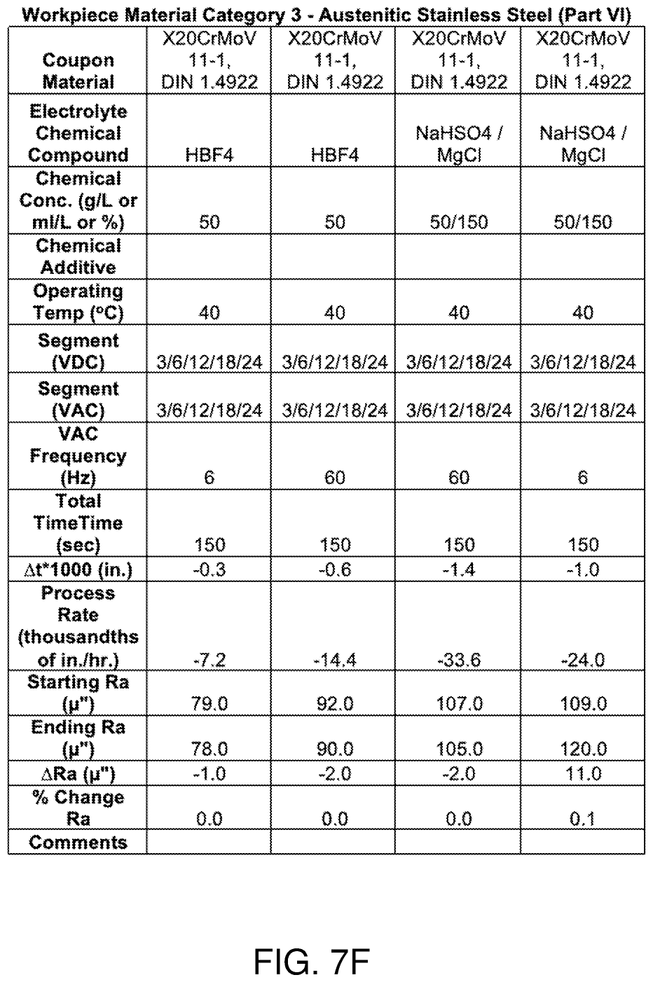

Additional data pertaining to the above experiments and additional experiments carried out on austenitic stainless steel is set forth in the tables presented in FIGS. 7A-7F.

### Workpiece Material Category 4—Martensitic Stainless Steel

### Experiment 14

In an aqueous electrolyte comprised of phosphoric acid (85 wt. %) at 67% by volume, sulfuric acid (50 wt. %) at 33% by volume, H2O at 5 wt. % and Lauric Aldehyde at 0.1 ml/L and 50° C., a coupon of 440C martensitic stainless steel, (UNS S44004, Fe-17Cr-0.75Mo-0.5Mn-0.5Ni-0.5Si) was acted upon by a Bimodal A/C and D/C power supply configured in accordance with the embodiments described herein. The operational scheme for this experiment provided alternating current at 600 Hz at 3 volts (maximum voltage using symmetric sinusoidal waveform) for 15 seconds, followed by direct current at 3 volts for 15 seconds, and repeated these two operational modes 5 times, increasing the voltage for both the alternating current mode and the direct current mode by 3 volts for the second pairing and by 6 volts for each of the third, fourth, and fifth pairing until reaching 24 volts in both the alternating current mode and the direct current mode in the final pairing. The total operation time was 2.5 minutes. This material experienced a negligible change in surface finish of 3μ″ while undergoing a minimal gage reduction of 0.008 inches per hour.

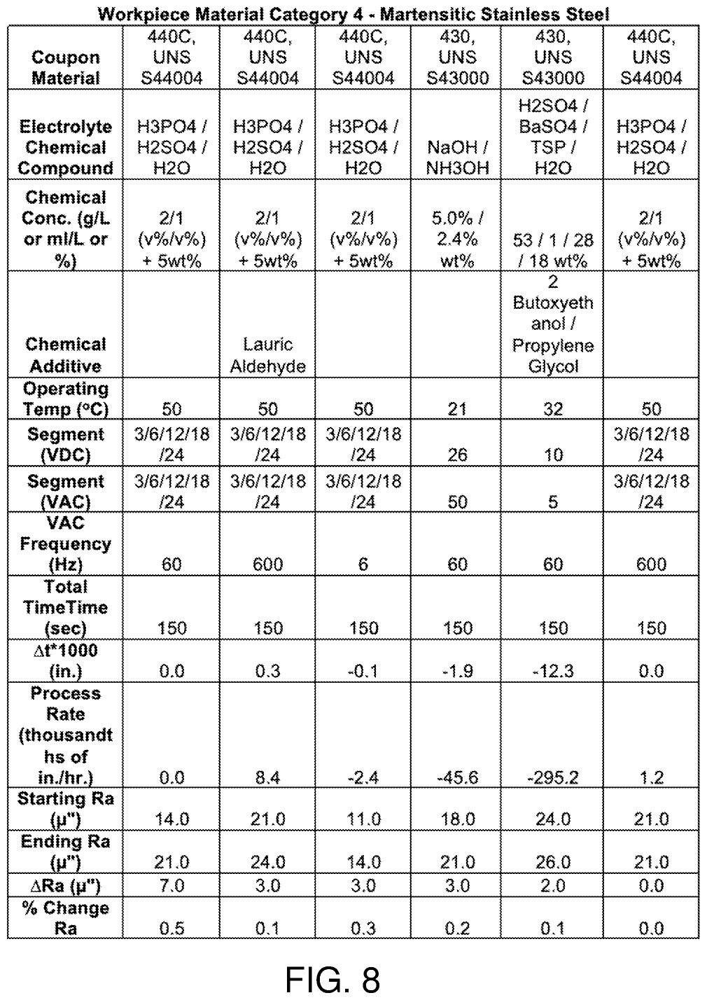

Additional data pertaining to the above experiments and additional experiments carried out on martensitic stainless steel is set forth in the tables presented in FIG. 8.

### Workpiece Material Category 5—Ferritic Stainless Steel, Carbon Steel, or Alloy Steel

### Experiment 15

In an aqueous electrolyte comprised of 5.0% by weight sodium hydroxide and 2.4% by weight ammonium hydroxide at 21° C., a coupon of 430 ferritic stainless steel (UNS S43000, Fe-17Cr-0.7Mn-0.60Si) was acted upon by a Bimodal A/C and D/C power supply configured in accordance with the embodiments described herein. The operational scheme for this experiment provided 60 Hz of alternating current at 50 volts (maximum voltage using symmetric sinusoidal waveform) for 15 seconds, followed by direct current at 26 volts for 15 seconds, and repeated these two operational modes 5 times for a total operation time of 2.5 minutes. This material experienced a gage reduction of 0.045 inches per hour and became mildly rougher as indicated by the increase in surface finish of 17%.

### Experiment 16

In an aqueous electrolyte comprised of 53% by weight sulfuric acid, 28% by weight trisodium phosphate, 18% by weight water and 1% by weight barium sulfate and 0.1 ml/L of 2-butoxyethanol/propylene glycol at 32° C., a coupon of 430 ferritic stainless steel (UNS S43000, Fe-17Cr-0.7Mn-0.60Si) was acted upon by a Bimodal A/C and D/C power supply configured in accordance with the embodiments described herein. The operational scheme for this experiment provided 60 Hz of alternating current at 5 volts (maximum voltage using symmetric sinusoidal waveform) for 15 seconds, followed by direct current at 10 volts for 15 seconds, and repeated these two operational modes 5 times for a total operation time of 2.5 minutes. This material demonstrated a rapid gage reduction of 0.295 inches per hour, and a 2μ″ Rₐ increase in surface finish.

### Experiment 17

In an aqueous electrolyte comprised of fluorboric acid (50 wt. %) at 50 ml/L and 40° C., a heat-treated coupon of low carbon steel alloy 15CDV6 (DIN 1.7734, Fe-1.4Cr-0.9Mo-0.2V-6Al-2Sn) was acted upon by a Bimodal A/C and D/C power supply configured in accordance with the embodiments described herein. The operational scheme for this experiment provided alternating current at 600 Hz at 3 volts (maximum voltage using symmetric sinusoidal waveform) for 15 seconds, followed by direct current at 3 volts for 15 seconds, and repeated these two operational modes 5 times, increasing the voltage for both the alternating current mode and the direct current mode by 3 volts for the second pairing and by 6 volts for each of the third, fourth, and fifth pairing until reaching 24 volts in both the alternating current mode and the direct current mode in the final pairing. The total operation time was 2.5 minutes. At the completion of the cycle, the material was bright and smooth, experiencing a reduction in surface finish of 26%, while undergoing a gage reduction of 0.024 inches per hour.

### Experiment 18

In an aqueous electrolyte comprised of fluorboric acid (50 wt. %) at 50 ml/L and 40° C., a heat-treated alloy steel coupon of AISI M2 molybdenum high-speed tool steel (UNS T11302, Fe-6 W-5Mo-2V-1C-0.4Cr-0.3Ni) was acted upon by a Bimodal A/C and D/C power supply configured in accordance with the embodiments described herein. The operational scheme for this experiment provided alternating current at 6 Hz at 3 volts (maximum voltage using symmetric sinusoidal waveform) for 15 seconds, followed by direct current at 3 volts for 15 seconds, and repeated these two operational modes 5 times, increasing the voltage for both the alternating current mode and the direct current mode by 3 volts for the second pairing and by 6 volts for each of the third, fourth, and fifth pairing until reaching 24 volts in both the alternating current mode and the direct current mode in the final pairing. The total operation time was 2.5 minutes. At the completion of the cycle, the material was free of the heat-treating oxide, was bright and smooth, experiencing a reduction in surface finish of 13%, while undergoing a gage reduction of 0.060 inches per hour.

### Experiment 19

In an aqueous electrolyte comprised of sodium bisulfate (50 g/L) and magnesium chloride (150 g/L) at 40° C., a heat-treated alloy steel coupon of AISI M2 molybdenum high-speed tool steel (UNS T11302, Fe-6 W-5Mo-2V-1C-0.4Cr-0.3Ni) was acted upon by a Bimodal A/C and D/C power supply configured in accordance with the embodiments described herein. The operational scheme for this experiment provided alternating current at 6 Hz at 3 volts (maximum voltage using symmetric sinusoidal waveform) for 15 seconds, followed by direct current at 3 volts for 15 seconds, and repeated these two operational modes 5 times, increasing the voltage for both the alternating current mode and the direct current mode by 3 volts for the second pairing and by 6 volts for each of the third, fourth, and fifth pairing until reaching 24 volts in both the alternating current mode and the direct current mode in the final pairing. The total operation time was 2.5 minutes. At the completion of the cycle, the material was free of the heat-treating oxide, experiencing a reduction in surface finish of 25%, while undergoing a gage reduction of 0.007 inches per hour.

### Experiment 20

In an aqueous electrolyte comprised of 53% by weight sulfuric acid, 28% by weight trisodium phosphate, 18% by weight water and 1% by weight barium sulfate and 0.1 ml/L of 2-butoxyethanol/propylene glycol at 82° C., a coupon of 1020 carbon steel (UNS G10200, Fe-0.2C-0.5Mn) was acted upon by a Bimodal A/C and D/C power supply configured in accordance with the embodiments described herein. The operational scheme for this experiment provided 60 Hz of alternating current at 2 volts (maximum voltage using symmetric sinusoidal waveform) for 15 seconds, followed by direct current at 1.2 volts for 15 seconds, and repeated these two operational modes 5 times for a total operation time of 2.5 minutes. At the completion of the cycle, the material experienced rapid material removal of 0.342 inches per hour and was polished while undergoing a 28% reduction in surface finish.

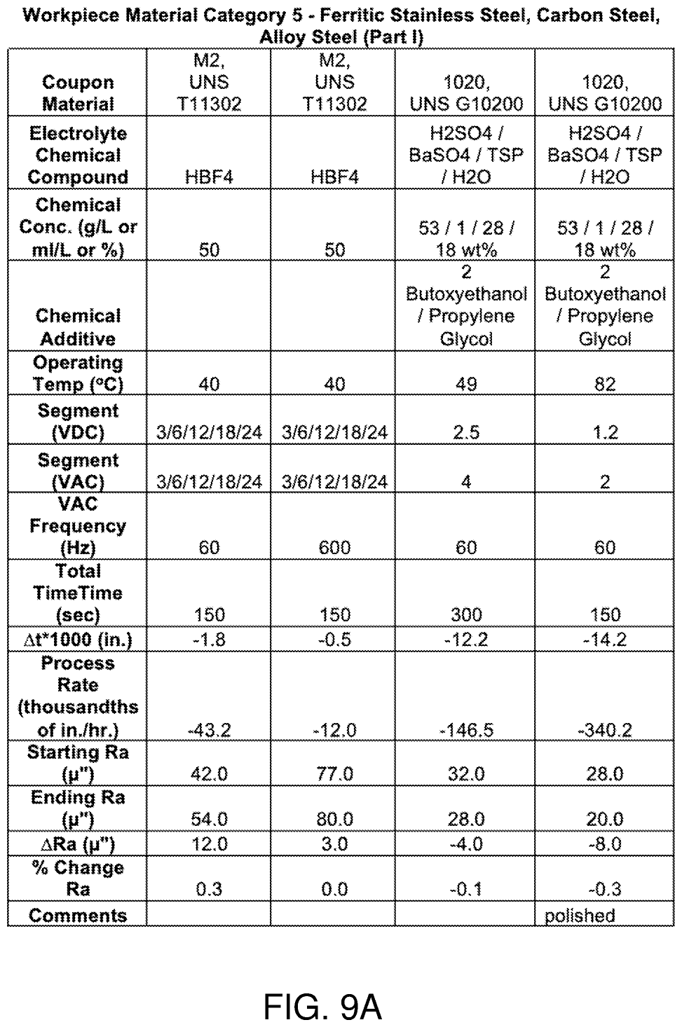

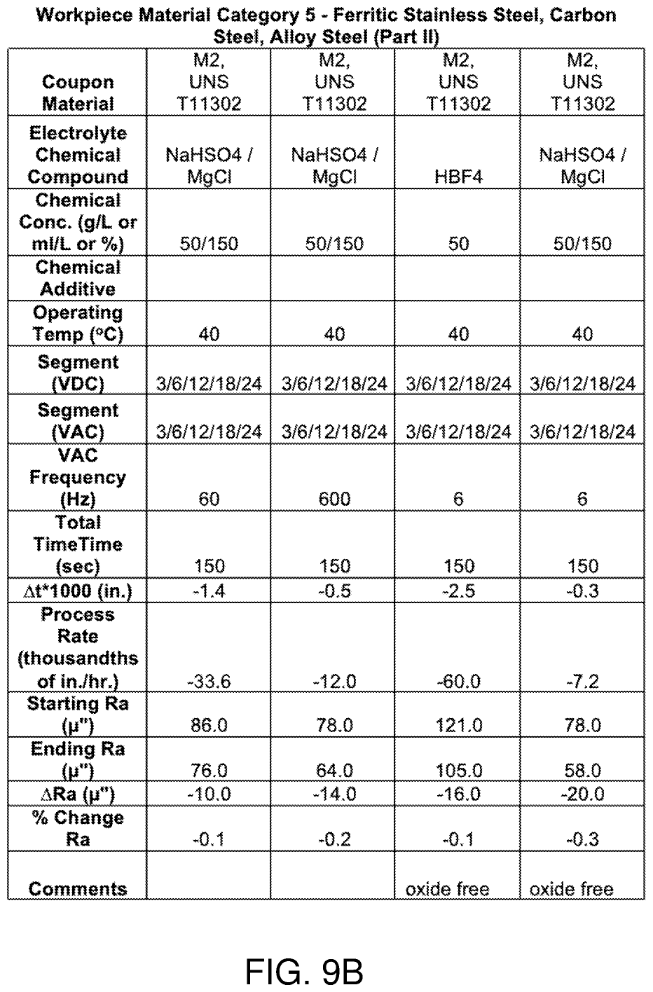

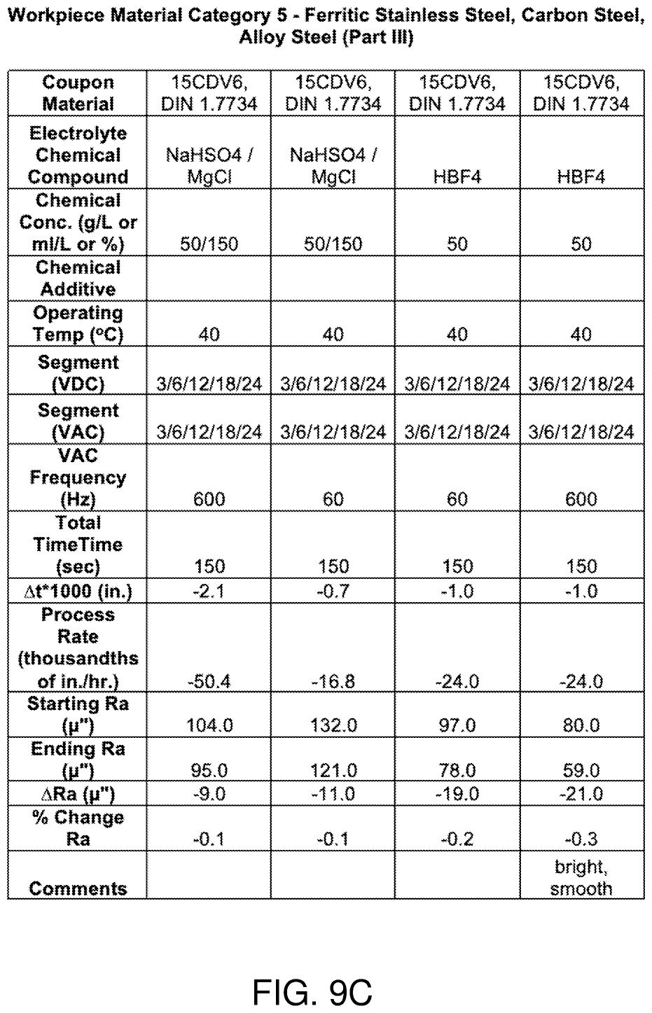

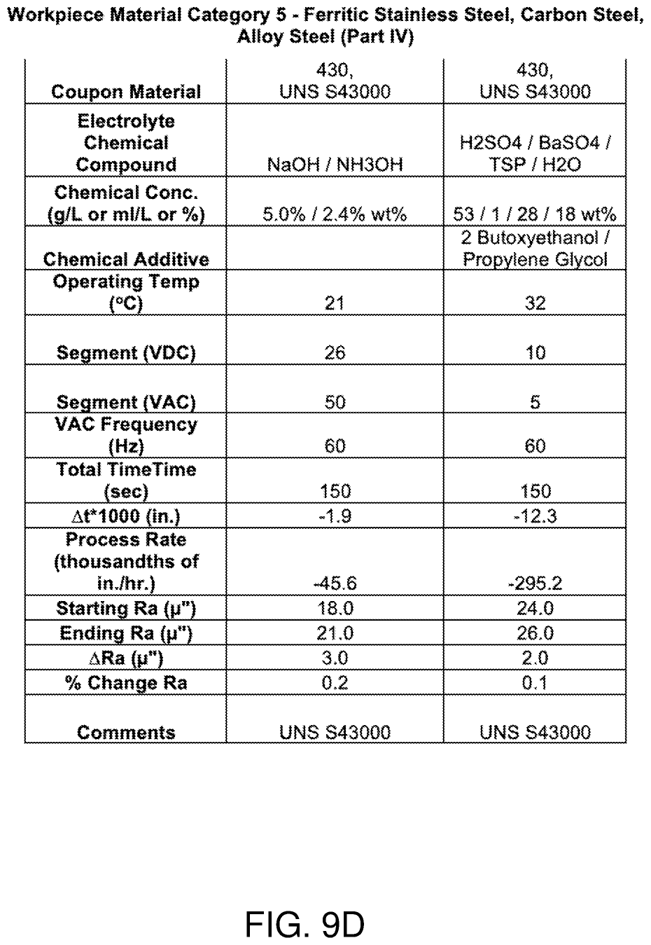

Additional data pertaining to the above experiments and additional experiments carried out on ferritic metals is set forth in the tables presented in FIGS. 9A-9D.

### Workpiece Material Category 6—Aluminum and Aluminum Alloys

### Experiment 21

In an aqueous electrolyte comprised of 53% by weight sulfuric acid, 28% by weight trisodium phosphate, 18% by weight water and 1% by weight barium sulfate and 0.1 ml/L of 2-butoxyethanol/propylene glycol at 36° C., a coupon of precipitation-hardened aluminum alloy 6061 (UNS A96061, Al-1Mn-0.6Si-0.28Cu-0.2Cr) was acted upon by a Bimodal A/C and D/C power supply configured in accordance with the embodiments described herein. The operational scheme for this experiment provided 60 Hz of alternating current at 10 volts (maximum voltage using symmetric sinusoidal waveform) for 15 seconds, followed by direct current at 12 volts for 15 seconds, and repeated these two operational modes 5 times for a total operation time of 2.5 minutes. At the completion of the cycle, the material exhibited a bright and reflective surface with a corresponding decrease in surface finish of 25% and a gage loss of 0.187 inches per hour. This polished surface is desirable for many applications and performed conventionally perchloric acid, a potentially explosive chemistry if allowed to crystalize in ventilation systems or from solution poor industrial housekeeping. It is believed that the bimodal power supplies are acting on and refreshing the bielby layer adjacent to the workpiece to advantageously affect the surface of the material.

### Experiment 22

In an aqueous electrolyte comprised of 5.0% by weight sodium hydroxide and 2.4% by weight ammonium hydroxide, at 24° C., a coupon of non-heat treatable aluminum alloy 5052 (UNS A95052, Al-2.5Mn-0.25Cr) was acted upon by a Bimodal A/C and D/C power supply configured in accordance with the embodiments described herein. The operational scheme for this experiment provided 60 Hz of alternating current at 50 volts (maximum voltage using symmetric sinusoidal waveform) for 15 seconds, followed by direct current at 26 volts for 15 seconds, and repeated these two operational modes 5 times for a total operation time of 2.5 minutes. Throughout the cycle, direct current amperage declined with time as an electrically resistive aluminum oxide would grow, while the amperage produced from the alternating current supply increased. At the completion of the cycle, the material exhibited a substantial growth of the aluminum oxide film thickness equal to 0.141 inches per hour and a corresponding increase of surface finish of 109%. It is believed the bimodal supply allowed for a rapid growth of film thickness by the direct current while the alternating current reactivated or ‘stripped’ the resistive layer of the film in the electrolyte refreshing the system for additional growth.

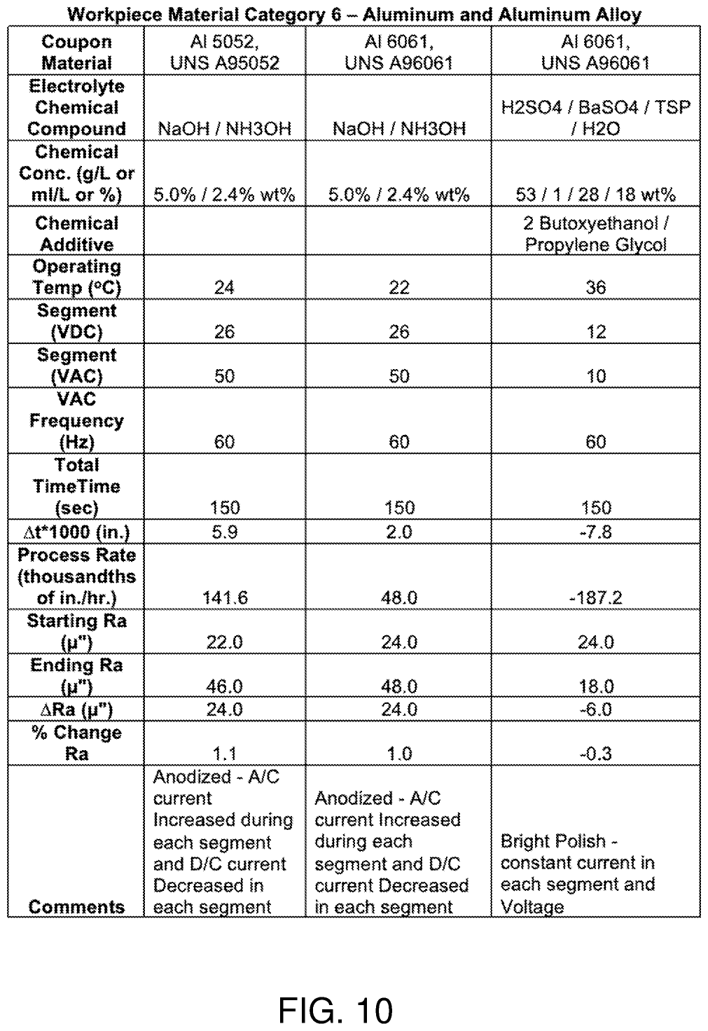

Additional data pertaining to the above experiments and additional experiments carried out on aluminum is set forth in the tables presented in FIG. 10.

### Workpiece Material Category 7—Copper and Copper Alloys

### Experiment 23

In an aqueous electrolyte comprised of 53% by weight sulfuric acid, 28% by weight trisodium phosphate, 18% by weight water and 1% by weight barium sulfate and 0.1 ml/L of 2-butoxyethanol/propylene glycol at 24° C., a coupon of AMS 4535 beryllium copper (UNS C17200, Cu-1.9Be-0.2Co) was acted upon by a Bimodal A/C and D/C power supply configured in accordance with the embodiments described herein. The operational scheme for this experiment provided 60 Hz of alternating current at 5 volts (maximum voltage using symmetric sinusoidal waveform) for 15 seconds, followed by direct current at 8.5 volts for 15 seconds, and repeated these two operational modes 5 times for a total operation time of 2.5 minutes. At the completion of the cycle, the material realized a substantial removal rate of 0.283 inches per hour, significant as this alloy is utilized for its corrosion resistance, particularly in downhole applications where resistance to sulfide compounds is of importance.

### Experiment 24

In an aqueous electrolyte comprised of 5.0% by weight sodium hydroxide and 2.4% by weight ammonium hydroxide at 21° C., a coupon of AMS 4535 beryllium copper (UNS C17200, Cu-1.9Be-0.2Co) was acted upon by a Bimodal A/C and D/C power supply configured in accordance with the embodiments described herein. The operational scheme for this experiment provided 60 Hz of alternating current at 50 volts (maximum voltage using symmetric sinusoidal waveform) for 15 seconds, followed by direct current at 26 volts for 15 seconds, and repeated these two operational modes 5 times for a total operation time of 2.5 minutes. At the completion of the cycle, the material realized a substantial removal rate of 0.084 inches per hour, significant as this alloy is utilized for its corrosion resistance, particularly in downhole applications where resistance to sulfide compounds is of importance.

### Experiment 25

In an aqueous electrolyte comprised of 5.0% by weight sodium hydroxide and 2.4% by weight ammonium hydroxide at 18° C., a coupon of 360 Free-Cutting Brass (UNS C36000Cu-35.5Zn-3Pb-0.35Fe) was acted upon by a Bimodal A/C and D/C power supply configured in accordance with the embodiments described herein. The operational scheme for this experiment provided 60 Hz of alternating current at 60 volts (maximum voltage using symmetric sinusoidal waveform) for 15 seconds, followed by direct current at 60 volts for 15 seconds, and repeated these two operational modes 5 times for a total operation time of 2.5 minutes. At the completion of the cycle, the material developed a uniform black appearance, resulting from a finely divided surface that trapped light and prevented its reflection, giving the perception of a black coating, irrespective of a surface finish change of 2μ″ of measured Ra.

### Experiment 26

In an aqueous electrolyte comprised of 53% by weight sulfuric acid, 28% by weight trisodium phosphate, 18% by weight water and 1% by weight barium sulfate and 0.1 ml/L of 2-butoxyethanol/propylene glycol at 28° C., a coupon of bearing bronze (UNS C93200, Cu-10Pb-10Sn) was acted upon by a Bimodal A/C and D/C power supply configured in accordance with the embodiments described herein. The operational scheme for this experiment provided 60 Hz of alternating current at 50 volts (maximum voltage using symmetric sinusoidal waveform) for 15 seconds, followed by direct current at 26 volts for 15 seconds, and repeated these two operational modes 5 times for a total operation time of 2.5 minutes. At the completion of the cycle, the material developed a uniform black appearance, resulting from a finely divided surface that trapped light and prevented its reflection, giving the perception of a black coating, irrespective of a surface finish change of 15μ″ of measured Ra.

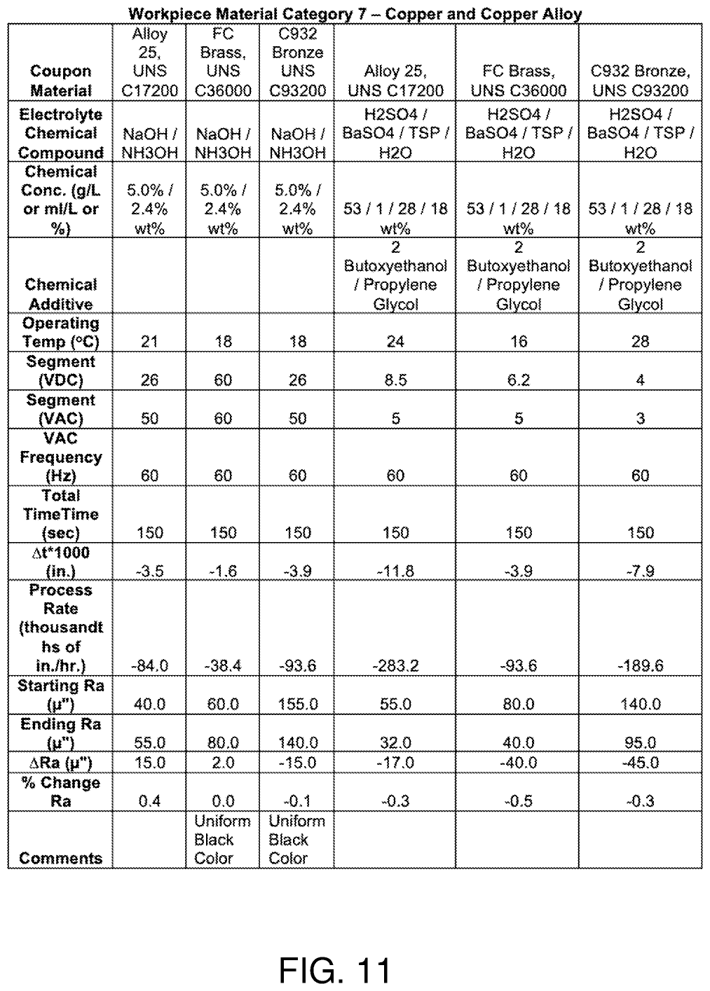

Additional data pertaining to the above experiments and additional experiments carried out on copper is set forth in the tables presented in FIG. 11.

From the foregoing, it will be appreciated that specific embodiments of the invention have been described herein for purposes of illustration, but that various modifications may be made without deviating from the scope of the invention. Accordingly, the invention is not limited except as by the appended claims.

Although the technology has been described in language that is specific to certain structures and materials, it is to be understood that the invention defined in the appended claims is not necessarily limited to the specific structures and materials described. Rather, the specific aspects are described as forms of implementing the claimed invention. Because many embodiments of the invention can be practiced without departing from the spirit and scope of the invention, the invention resides in the claims hereinafter appended.

Unless otherwise indicated, all number or expressions, such as those expressing dimensions, physical characteristics, etc., used in the specification (other than the claims) are understood as modified in all instances by the term “approximately”. At the very least, and not as an attempt to limit the application of the doctrine of equivalents to the claims, each numerical parameter recited in the specification or claims which is modified by the term “approximately” should at least be construed in light of the number of recited significant digits and by applying rounding techniques. Moreover, all ranges disclosed herein are to be understood to encompass and provide support for claims that recite any and all sub-ranges or any and all individual values subsumed therein. For example, a stated range of 1 to 10 should be considered to include and provide support for claims that recite any and all sub-ranges or individual values that are between and/or inclusive of the minimum value of 1 and the maximum value of 10; that is, all sub-ranges beginning with a minimum value of 1 or more and ending with a maximum value of 10 or less (e.g., 5.5 to 10, 2.34 to 3.56, and so forth) or any values from 1 to 10 (e.g., 3, 5.8, 9.9994, and so forth).

I/We claim:

1. A bimodal method for affecting the surface of an electrically conductive metal workpiece, comprising:
immersing at least a surface of an electrically conductive metal workpiece in an electrolyte solution;
immersing at least a surface of an electrode in the electrolyte solution;
initiating a first operational mode, the first operational mode comprising either applying a direct current across the electrolyte solution between the electrically conductive metal workpiece and the electrode or applying an alternating current across the electrolyte solution between the electrically conductive metal workpiece and the electrode;
terminating the first operational mode;
initiating a second operational mode, the second operational mode comprising either applying an alternating current across the electrolyte solution between the electrically conductive metal workpiece and the electrode or applying a direct current across the electrolyte solution between the electrically conductive metal workpiece and the electrode, wherein the second operational mode is different from the first operational mode; and
terminating the second operational mode;
wherein the electrically conductive metal workpiece comprises pure Ti, Zr, Nb, Hf, Ta, or V, or a Ti-, Zr-, Nb-, Hf-, Ta-, or V-based alloy.

2. The bimodal method of claim 1, wherein the steps of initiating the first operational mode, terminating the first operational mode, initiating the second operational mode, and terminating the second operational mode are repeated sequentially two or more times.

3. The bimodal method of claim 1, wherein applying the direct current comprises applying the direct current at a constant voltage.

4. The bimodal method of claim 1, wherein applying alternating current comprises applying the alternating current as a sinusoidal alternating current having a constant maximum voltage.

5. The bimodal method of claim 2, wherein applying the direct current comprises applying the direct current at a constant voltage and applying the alternating current comprises applying the alternating current as a sinusoidal alternating current having a constant maximum voltage.

6. The bimodal method of claim 5, wherein:
a first iteration of the steps of initiating the first operational mode, terminating the first operational mode, initiating the second operational mode, and terminating the second operational mode is carried out using a first value for the direct current constant voltage and a first value for the alternating current constant maximum voltage;
a subsequent iteration of the steps of initiating the first operational mode, terminating the first operational mode, initiating the second operational mode, and terminating the second operational mode is carried out using a second value for the direct current constant voltage and a second value for the alternating current constant maximum voltage; and
the second value for the direct current constant voltage is greater than the first value for the direct current constant voltage, and the second value for the alternating current constant maximum voltage is less than the first value for the alternating current constant maximum voltage.

7. The bimodal method of claim 1, wherein the electrolyte solution has a conductivity greater than 0.011649 micro-siemens per cm at 0° C.

8. The bimodal method of claim 1, wherein the electrolyte solution has a temperature in the range of from about 10° C. to about 100° C.

9. The bimodal method of claim 1, wherein the electrolyte solution comprises one or more ionic solutes.

10. The bimodal method of claim 9, wherein the one or more ionic solutes are selected from the group consisting of alkali elements, compounds including alkali elements, alkali earth elements, compounds including alkali earth elements, transition elements, compounds including transition elements, post transition elements, and compounds including post transition elements.

11. The bimodal method of claim 9, wherein the one or more ionic solutes are selected from the group consisting of metalloids, reactive non-metals, salts of non-reactive metals, acids of non-reactive metals, bases of non-reactive metals, oxides of non-reactive metals, and halogens.

12. The bimodal method of claim 1, wherein the electrolyte solution comprises one or more organic compounds.

13. The bimodal method of claim 12, wherein the one or more organic compounds are selected from the group consisting of alcohols, aldehydes, ketones, carboxylic acids, and amines.

14. The bimodal method of claim 1, wherein the electrolyte solution comprises one or more surfactants.

15. The bimodal method of claim 1, further comprising:
agitating the electrolyte solution during at least a portion of the first operational mode, at least a portion of the second operational mode, or both.

16. The bimodal method of claim 15, wherein agitating the electrolyte solution comprises thermal agitation, physical agitation, or both.

17. The bimodal method of claim 1, wherein applying the direct current across the electrolyte solution between the electrically conductive metal workpiece and the electrode comprises applying the direct current from the electrically conductive metal workpiece to the electrode.

18. The bimodal method of claim 1, wherein applying the direct current across the electrolyte solution between the electrically conductive metal workpiece and the electrode comprises applying the direct current from the electrode to the electrically conductive metal workpiece.

19. The bimodal method of claim 5, wherein the constant voltage is in the range of from −480 V to +480 V.

20. The bimodal method of claim 1, wherein applying the direct current across the electrolyte solution between the electrically conductive metal workpiece and the electrode is carried out for a period of 1 millisecond or greater.

21. The bimodal method of claim 1, wherein applying the alternating current across the electrolyte solution between the electrically conductive metal workpiece and the electrode is carried out for a period of 1 millisecond or greater.

22. The bimodal method of claim 5, wherein the constant maximum voltage of the sinusoidal alternating current is from greater than 0 V to about +480 V.

23. The bimodal method of claim 5, wherein the frequency of the sinusoidal alternating current is in the range of from about 6 Hertz to about 600 MHZ.

24. The bimodal method of claim 1, wherein a distance between the electrode and the electrically conductive metal workpiece is greater than about 0.003 inches.

25. The bimodal method of claim 1, wherein the method is carried out to deposit material on the surface of the electrically conductive metal workpiece.

26. The bimodal method of claim 1, wherein the method is carried out to remove material from the surface of the electrically conductive metal workpiece.

27. The bimodal method of claim 26, wherein material is removed from the surface of the electrically conductive metal workpiece to achieve a surface finish measurement in the range of from 1 Ra to 500 Ra.

28. The bimodal method of claim 1, wherein the method is carried out to alter the surface chemistry of a surface of the electrically conductive metal workpiece.

29. The bimodal method of claim 28, wherein altering the surface chemistry of the surface of the electrically conductive metal workpiece comprises removing a metallic material, adding an oxide layer, or both.

30. The bimodal method of claim 28, wherein altering the surface chemistry of the surface of the electrically conductive metal workpiece comprises removing hydrogen, preventing or inhibiting hydrogen attachment, or both.

31. The bimodal method of claim 28, wherein altering the surface chemistry of the surface of the electrically conductive metal workpiece comprises charging hydrogen to at least the surface of the electrically conductive metal workpiece.

32. The bimodal method of claim 1, wherein applying the direct current comprises applying the direct current at a first constant voltage for a first period of time followed by applying the direct current at a second constant voltage for a second period of time.

33. The bimodal method of claim 1, wherein applying the direct current comprises applying the direct current at a positive polarity for a first period of time followed by applying the direct current at a negative polarity for a second period of time, or applying the direct current at a negative polarity for a first period of time followed by applying the direct current at a positive polarity for a second period of time.

34. The bimodal method of claim 1, wherein applying the alternating current comprises applying the alternating current at a first waveform for a first period of time followed by applying the alternating current at a second waveform for a second period of time.

35. The bimodal method of claim 33, wherein the first waveform differs from the second waveform in one or more of amplitude, frequency, wavelength, and shape.

36. A system configured for affecting the surface of an electrically conductive metal workpiece, comprising:
an electrolyte solution bath;
an electrically conductive metal workpiece, at least one surface of which is immersed in the electrolyte solution bath;
an electrode, at least one surface of which is immersed in the electrolyte solution bath;
a DC power supply, wherein a first terminal of the DC power supply is connected to the electrically conductive metal workpiece and a second terminal of the DC power supply is connected to the electrode; and
an AC power supply, wherein a first terminal of the AC power supply is connected to the electrically conductive metal workpiece and a second terminal of the AC power supply is connected to the electrode;
wherein, in a first operational mode, either the DC power supply is configured to apply only direct current across the electrolyte solution between the electrically conductive metal workpiece and the electrode or the AC power supply is configured to apply only alternating current across the electrolyte solution between the electrically conductive metal workpiece and the electrode direct current;
wherein, in a second operational mode, either the AC power supply is configured to apply only alternating current across the electrolyte solution between the electrically conductive metal workpiece and the electrode direct current or the DC power supply is configured to apply only direct current across the electrolyte solution between the electrically conductive metal workpiece and the electrode;
wherein the first operational mode is different from the second operational mode;
wherein the system is configured to alternate between the first operational mode and the second operational mode; and
wherein the electrically conductive metal workpiece comprises Ti, Zr, Nb, Hf, Ta, or V, or a Ti-, Zr-, Nb-, Hf-, Ta-, or V-based alloy.

37. The system of claim 36, wherein the first terminal of the DC power supply is the positive terminal and the second terminal of the DC power supply is the negative terminal.

38. The system of claim 36, wherein the first terminal of the DC power supply is the negative terminal and the second terminal of the DC power supply is the positive terminal.

39. The system of claim 36, wherein the DC power supply is configured to apply the direct current at a constant voltage during the first or second operational mode.

40. The system of claim 36, wherein the AC power supply is configured to apply the alternating current as sinusoidal alternating current having a constant maximum voltage during the first or second operational mode.

41. The system of claim 36, wherein the DC power supply is configured to apply the direct current at a constant voltage during the first or second operational mode and the AC power supply is configured to apply the alternating current as a sinusoidal alternating current having a constant maximum voltage during the first or second operational mode.

42. The system of claim 36, further comprising:
means for agitating the electrolyte solution bath.

43. The system of claim 42, wherein the means for agitating the electrolyte solution bath comprises mechanical agitation means.

44. The system of claim 42, wherein the means for mixing the electrolyte solution bath comprises thermal agitation means.

45. The system of claim 41, wherein the constant voltage is in the range of from −480 V to +480 V.

46. The system of claim 41, wherein the first operational mode is carried out for a period of 1 millisecond or greater and the second operational mode is carried out for a period of 1 millisecond or greater.

47. The system of claim 41, wherein the constant maximum voltage of the sinusoidal alternating current is from greater than 0 V to about +480 V.

48. The system of claim 41, wherein the frequency of the sinusoidal alternating current is in the range of from about 6 Hertz to about 600 MHZ.

49. The system of claim 36, wherein, during the first or second operational mode, the DC power supply is configured to apply the direct current at a first constant voltage for a first period of time followed by applying the direct current at a second constant voltage for a second period of time.

50. The system of claim 36, wherein, during the first or second operational mode, the DC power supply is configured to apply the direct current at a positive polarity for a first period of time followed by applying the direct current at a negative polarity for a second period of time, or to apply the direct current at a negative polarity for a first period of time followed by applying the direct current at a positive polarity for a second period of time.

51. The system of claim 36, wherein, during the first or second operational mode, the AC power supply is configured to apply the alternating current at a first waveform for a first period of time followed by applying the alternating current at a second waveform for a second period of time.

52. The system of claim 51, wherein the first waveform differs from the second waveform in one or more of amplitude, frequency, wavelength, and shape.

53. The biomodal method of claim 1, further comprising:
monitoring one or more operating parameters of the method;
analyzing the one or more operating parameters to determine if an adjustment to the one or more operating parameters is required to alter an aspect of a barrier layer formed on the workpiece; and
when it is determined that an adjustment is required, automatically adjusting the one or more operating parameters to alter an aspect of the barrier layer.

54. The bimodal method of claim 53, wherein the one or more operating parameter is selected from the group consisting of: the voltage, action, amplitude, dwell or form of the direct current, the voltage, action, amplitude, dwell or form of the alternating current, the duration of the direct current, the duration of the alternating current, the cycling of the alternating current, the temperature of the electrolyte solution, the agitation of the electrolyte solution, the composition of the electrolyte solution, the conductivity of the electrolyte solution, or any combination thereof.

55. The bimodal method of claim 53, wherein the workpiece is a first workpiece and the method further comprises:
replacing the first workpiece with a second workpiece; and
repeating the steps of initiating the first operational mode, terminating the first operational mode, initiating the second operational mode, terminating the second operational mode, monitoring the operating parameters, analyzing the operating parameters, and adjusting the operating parameters in a manner that affects the second workpiece in the same manner as the first workpiece.

56. The bimodal method of claim 1, wherein the electrolyte solution is free or substantially free of nitrogen and nitrogen-containing compounds.

57. The system of claim 36, further comprising:
an operating parameter control system, the operating parameter control system configured to:
monitor one or more operating parameters of the system;
analyze the one or more operating parameters to determine if an adjustment to the one or more operating parameters is required to alter an aspect of a barrier layer formed on the workpiece; and
when it is determined that an adjustment is required, automatically adjust the one or more operating parameters to alter an aspect of the barrier layer.

58. The system of claim 57, wherein the one or more operating parameter is selected from the group consisting of: the voltage, action, amplitude, dwell or form of the direct current, the voltage, action, amplitude, dwell or form of the alternating current, the duration of the direct current, the duration of the alternating current, the cycling of the alternating current, the temperature of the electrolyte solution, the agitation of the electrolyte solution, the composition of the electrolyte solution, the conductivity of the electrolyte solution, or any combination thereof.

59. A bimodal method for affecting the surface of an electrically conductive metal workpiece, comprising:
immersing at least a surface of an electrically conductive metal workpiece in an electrolyte solution;
immersing at least a surface of an electrode in the electrolyte solution;
initiating a first operational mode, the first operational mode comprising either applying a direct current across the electrolyte solution between the electrically conductive metal workpiece and the electrode or applying an alternating current across the electrolyte solution between the electrically conductive metal workpiece and the electrode;
terminating the first operational mode;
initiating a second operational mode, the second operational mode comprising either applying an alternating current across the electrolyte solution between the electrically conductive metal workpiece and the electrode or applying a direct current across the electrolyte solution between the electrically conductive metal workpiece and the electrode, wherein the second operational mode is different from the first operational mode; and
terminating the second operational mode;
wherein the electrically conductive metal workpiece comprises pure Ni, a Ni-based alloy, a Co-based alloy, or a titanium aluminide.

60. A system configured for affecting the surface of an electrically conductive metal workpiece, comprising:
an electrolyte solution bath;
an electrically conductive metal workpiece, at least one surface of which is immersed in the electrolyte solution bath;
an electrode, at least one surface of which is immersed in the electrolyte solution bath;
a DC power supply, wherein a first terminal of the DC power supply is connected to the electrically conductive metal workpiece and a second terminal of the DC power supply is connected to the electrode; and
an AC power supply, wherein a first terminal of the AC power supply is connected to the electrically conductive metal workpiece and a second terminal of the AC power supply is connected to the electrode;
wherein, in a first operational mode, either the DC power supply is configured to apply only direct current across the electrolyte solution between the electrically conductive metal workpiece and the electrode or the AC power supply is configured to apply only alternating current across the electrolyte solution between the electrically conductive metal workpiece and the electrode direct current;
wherein, in a second operational mode, either the AC power supply is configured to apply only alternating current across the electrolyte solution between the electrically conductive metal workpiece and the electrode direct current or the DC power supply is configured to apply only direct current across the electrolyte solution between the electrically conductive metal workpiece and the electrode;
wherein the first operational mode is different from the second operational mode;
wherein the system is configured to alternate between the first operational mode and the second operational mode; and
wherein the electrically conductive metal workpiece comprises pure Ni, a Ni-based alloy, a Co-based alloy, or a titanium aluminide.

61. A bimodal method for affecting the surface of an electrically conductive metal workpiece, comprising:
immersing at least a surface of an electrically conductive metal workpiece in an electrolyte solution;
immersing at least a surface of an electrode in the electrolyte solution;
initiating a first operational mode, the first operational mode comprising either applying a direct current across the electrolyte solution between the electrically conductive metal workpiece and the electrode or applying an alternating current across the electrolyte solution between the electrically conductive metal workpiece and the electrode;
terminating the first operational mode;
initiating a second operational mode, the second operational mode comprising either applying an alternating current across the electrolyte solution between the electrically conductive metal workpiece and the electrode or applying a direct current across the electrolyte solution between the electrically conductive metal workpiece and the electrode, wherein the second operational mode is different from the first operational mode; and
terminating the second operational mode;
wherein the electrically conductive metal workpiece comprises an austenitic stainless steel.

62. A system configured for affecting the surface of an electrically conductive metal workpiece, comprising:
an electrolyte solution bath;
an electrically conductive metal workpiece, at least one surface of which is immersed in the electrolyte solution bath;
an electrode, at least one surface of which is immersed in the electrolyte solution bath;
a DC power supply, wherein a first terminal of the DC power supply is connected to the electrically conductive metal workpiece and a second terminal of the DC power supply is connected to the electrode; and
an AC power supply, wherein a first terminal of the AC power supply is connected to the electrically conductive metal workpiece and a second terminal of the AC power supply is connected to the electrode;
wherein, in a first operational mode, either the DC power supply is configured to apply only direct current across the electrolyte solution between the electrically conductive metal workpiece and the electrode or the AC power supply is configured to apply only alternating current across the electrolyte solution between the electrically conductive metal workpiece and the electrode direct current;
wherein, in a second operational mode, either the AC power supply is configured to apply only alternating current across the electrolyte solution between the electrically conductive metal workpiece and the electrode direct current or the DC power supply is configured to apply only direct current across the electrolyte solution between the electrically conductive metal workpiece and the electrode;
wherein the first operational mode is different from the second operational mode;
wherein the system is configured to alternate between the first operational mode and the second operational mode; and
wherein the electrically conductive metal workpiece comprises an austenitic stainless steel.

63. A bimodal method for affecting the surface of an electrically conductive metal workpiece, comprising:
immersing at least a surface of an electrically conductive metal workpiece in an electrolyte solution;
immersing at least a surface of an electrode in the electrolyte solution;
initiating a first operational mode, the first operational mode comprising either applying a direct current across the electrolyte solution between the electrically conductive metal workpiece and the electrode or applying an alternating current across the electrolyte solution between the electrically conductive metal workpiece and the electrode;
terminating the first operational mode;
initiating a second operational mode, the second operational mode comprising either applying an alternating current across the electrolyte solution between the electrically conductive metal workpiece and the electrode or applying a direct current across the electrolyte solution between the electrically conductive metal workpiece and the electrode, wherein the second operational mode is different from the first operational mode; and
terminating the second operational mode;
wherein the electrically conductive metal workpiece comprises a martensitic stainless steel.

64. A system configured for affecting the surface of an electrically conductive metal workpiece, comprising:
an electrolyte solution bath;
an electrically conductive metal workpiece, at least one surface of which is immersed in the electrolyte solution bath;
an electrode, at least one surface of which is immersed in the electrolyte solution bath;
a DC power supply, wherein a first terminal of the DC power supply is connected to the electrically conductive metal workpiece and a second terminal of the DC power supply is connected to the electrode; and
an AC power supply, wherein a first terminal of the AC power supply is connected to the electrically conductive metal workpiece and a second terminal of the AC power supply is connected to the electrode;
wherein, in a first operational mode, either the DC power supply is configured to apply only direct current across the electrolyte solution between the electrically conductive metal workpiece and the electrode or the AC power supply is configured to apply only alternating current across the electrolyte solution between the electrically conductive metal workpiece and the electrode direct current;
wherein, in a second operational mode, either the AC power supply is configured to apply only alternating current across the electrolyte solution between the electrically conductive metal workpiece and the electrode direct current or the DC power supply is configured to apply only direct current across the electrolyte solution between the electrically conductive metal workpiece and the electrode;
wherein the first operational mode is different from the second operational mode;
wherein the system is configured to alternate between the first operational mode and the second operational mode; and
wherein the electrically conductive metal workpiece comprises a martensitic stainless steel.

65. A bimodal method for affecting the surface of an electrically conductive metal workpiece, comprising:
immersing at least a surface of an electrically conductive metal workpiece in an electrolyte solution;
immersing at least a surface of an electrode in the electrolyte solution;
initiating a first operational mode, the first operational mode comprising either applying a direct current across the electrolyte solution between the electrically conductive metal workpiece and the electrode or applying an alternating current across the electrolyte solution between the electrically conductive metal workpiece and the electrode;
terminating the first operational mode;
initiating a second operational mode, the second operational mode comprising either applying an alternating current across the electrolyte solution between the electrically conductive metal workpiece and the electrode or applying a direct current across the electrolyte solution between the electrically conductive metal workpiece and the electrode, wherein the second operational mode is different from the first operational mode; and
terminating the second operational mode;
wherein the electrically conductive metal workpiece comprises a ferritic stainless steel, a carbon steel, or an alloy steel.

66. A system configured for affecting the surface of an electrically conductive metal workpiece, comprising:
an electrolyte solution bath;
an electrically conductive metal workpiece, at least one surface of which is immersed in the electrolyte solution bath;
an electrode, at least one surface of which is immersed in the electrolyte solution bath;
a DC power supply, wherein a first terminal of the DC power supply is connected to the electrically conductive metal workpiece and a second terminal of the DC power supply is connected to the electrode; and
an AC power supply, wherein a first terminal of the AC power supply is connected to the electrically conductive metal workpiece and a second terminal of the AC power supply is connected to the electrode;
wherein, in a first operational mode, either the DC power supply is configured to apply only direct current across the electrolyte solution between the electrically conductive metal workpiece and the electrode or the AC power supply is configured to apply only alternating current across the electrolyte solution between the electrically conductive metal workpiece and the electrode direct current;
wherein, in a second operational mode, either the AC power supply is configured to apply only alternating current across the electrolyte solution between the electrically conductive metal workpiece and the electrode direct current or the DC power supply is configured to apply only direct current across the electrolyte solution between the electrically conductive metal workpiece and the electrode;
wherein the first operational mode is different from the second operational mode;
wherein the system is configured to alternate between the first operational mode and the second operational mode; and
wherein the electrically conductive metal workpiece comprises a ferritic stainless steel, a carbon steel, or an alloy steel.

67. A bimodal method for affecting the surface of an electrically conductive metal workpiece, comprising:
immersing at least a surface of an electrically conductive metal workpiece in an electrolyte solution;
immersing at least a surface of an electrode in the electrolyte solution;
initiating a first operational mode, the first operational mode comprising either applying a direct current across the electrolyte solution between the electrically conductive metal workpiece and the electrode or applying an alternating current across the electrolyte solution between the electrically conductive metal workpiece and the electrode;
terminating the first operational mode;
initiating a second operational mode, the second operational mode comprising either applying an alternating current across the electrolyte solution between the electrically conductive metal workpiece and the electrode or applying a direct current across the electrolyte solution between the electrically conductive metal workpiece and the electrode, wherein the second operational mode is different from the first operational mode; and
terminating the second operational mode;
wherein the electrically conductive metal workpiece comprises pure aluminum or an aluminum alloy.

68. A system configured for affecting the surface of an electrically conductive metal workpiece, comprising:
an electrolyte solution bath;
an electrically conductive metal workpiece, at least one surface of which is immersed in the electrolyte solution bath;
an electrode, at least one surface of which is immersed in the electrolyte solution bath;
a DC power supply, wherein a first terminal of the DC power supply is connected to the electrically conductive metal workpiece and a second terminal of the DC power supply is connected to the electrode; and
an AC power supply, wherein a first terminal of the AC power supply is connected to the electrically conductive metal workpiece and a second terminal of the AC power supply is connected to the electrode;
wherein, in a first operational mode, either the DC power supply is configured to apply only direct current across the electrolyte solution between the electrically conductive metal workpiece and the electrode or the AC power supply is configured to apply only alternating current across the electrolyte solution between the electrically conductive metal workpiece and the electrode direct current;
wherein, in a second operational mode, either the AC power supply is configured to apply only alternating current across the electrolyte solution between the electrically conductive metal workpiece and the electrode direct current or the DC power supply is configured to apply only direct current across the electrolyte solution between the electrically conductive metal workpiece and the electrode;
wherein the first operational mode is different from the second operational mode;
wherein the system is configured to alternate between the first operational mode and the second operational mode; and
wherein the electrically conductive metal workpiece comprises pure aluminum or an aluminum alloy.

69. A bimodal method for affecting the surface of an electrically conductive metal workpiece, comprising:
immersing at least a surface of an electrically conductive metal workpiece in an electrolyte solution;
immersing at least a surface of an electrode in the electrolyte solution;
initiating a first operational mode, the first operational mode comprising either applying a direct current across the electrolyte solution between the electrically conductive metal workpiece and the electrode or applying an alternating current across the electrolyte solution between the electrically conductive metal workpiece and the electrode;
terminating the first operational mode;
initiating a second operational mode, the second operational mode comprising either applying an alternating current across the electrolyte solution between the electrically conductive metal workpiece and the electrode or applying a direct current across the electrolyte solution between the electrically conductive metal workpiece and the electrode, wherein the second operational mode is different from the first operational mode; and
terminating the second operational mode;
wherein the electrically conductive metal workpiece comprises pure copper or a copper alloy.

70. A system configured for affecting the surface of an electrically conductive metal workpiece, comprising:
an electrolyte solution bath;
an electrically conductive metal workpiece, at least one surface of which is immersed in the electrolyte solution bath;
an electrode, at least one surface of which is immersed in the electrolyte solution bath;
a DC power supply, wherein a first terminal of the DC power supply is connected to the electrically conductive metal workpiece and a second terminal of the DC power supply is connected to the electrode; and
an AC power supply, wherein a first terminal of the AC power supply is connected to the electrically conductive metal workpiece and a second terminal of the AC power supply is connected to the electrode;
wherein, in a first operational mode, either the DC power supply is configured to apply only direct current across the electrolyte solution between the electrically conductive metal workpiece and the electrode or the AC power supply is configured to apply only alternating current across the electrolyte solution between the electrically conductive metal workpiece and the electrode direct current;
wherein, in a second operational mode, either the AC power supply is configured to apply only alternating current across the electrolyte solution between the electrically conductive metal workpiece and the electrode direct current or the DC power supply is configured to apply only direct current across the electrolyte solution between the electrically conductive metal workpiece and the electrode;
wherein the first operational mode is different from the second operational mode;
wherein the system is configured to alternate between the first operational mode and the second operational mode; and
wherein the electrically conductive metal workpiece comprises pure copper or a copper alloy.
